(19) United States
(12) Patent Application Publication
(10) Pub. No.: US 2022/0353263 A1
(43) Pub. Date: Nov. 3, 2022

(54) SYSTEMS AND METHODS FOR SECURING NETWORK FUNCTION SUBSCRIBE NOTIFICATION PROCESS

(71) Applicant: Verizon Patent and Licensing Inc., Basking Ridge, NJ (US)

(72) Inventors: Vinod Kumar Choyi, Conshohocken, PA (US); Ali Imdad Malik, East Brunswick, NJ (US); Sudhakar Reddy Patil, Flower Mound, TX (US)

(21) Appl. No.: 17/242,419

(22) Filed: Apr. 28, 2021

(51) Int. Cl. H04L 29/06; H04W 12/06; H04L 9/32; H04W 12/08; H04W 12/122

(52) U.S. Cl. CPC H04L 63/10; H04W 12/06; H04L 63/08; H04L 9/3213; H04L 63/20; H04W 12/08; H04L 63/1458; H04W 12/122; H04L 2463/141; H04L 12/4641

(57) ABSTRACT

A network device receives, from a requester, an access token request associated with subscribing a consumer network function (NF) to a resource provided by a producer NF, where the access token request includes a notification identifier identifying where the consumer NF is to receive content and/or notifications, associated with the resource, from the producer NF. The network device validates the requester and generates an access token and an access token response based on successfully validating the requester. The network device signs the notification identifier as a component of the access token response and sends the access token response, with the signed notification identifier, to the requester for use in requesting a subscription to the resource for the consumer NF from the producer NF.

### BACKGROUND

As networks move to a Software Defined Network (SDN) model, dedicated hardware devices/components that have traditionally implemented particular network functions are being replaced by virtual network functions (VNFs). VNFs include network functions that have been moved into software that runs on commodity hardware. VNFs may be executed as one or more virtual machines (VMs) on top of the hardware networking infrastructure. VNFs typically increase network scalability and agility, while enabling better use of network resources. VNFs additionally reduce power consumption and reduce the use of available physical space due to the VNFs replacing physical hardware. VNFs, thus, reduce operational and capital costs.

### BRIEF DESCRIPTION OF THE DRAWINGS

FIGS. 1A and 1B depict two typical scenarios in which a consumer network function (NF) subscribes, or is subscribed by another entity, to a resource of a producer NF;

FIG. 2A illustrates a scenario in which an attacker may exploit the resource subscription process to cause denial of service attacks at a victim consumer NF;

FIG. 2B illustrates a scenario in which an attacker may exploit the resource subscription process to cause intentional or unintentional denial of service attacks at a Service Communication Proxy involved in routing data units from producer NFs to target consumer NFs;

FIG. 3 depicts an exemplary network environment in which NFs may subscribe to resources provided by other NFs;

FIG. 4 depicts an example of a network environment that includes a mobile network;

FIG. 5 is a diagram that depicts exemplary components of a device that may correspond to devices and network functions (NFs) shown in FIGS. 1A-4;

FIG. 6 illustrates an exemplary access token that may be used for enabling token-based authorization to a resource of a producer NF;

FIG. 7 illustrates an exemplary process for registering a consumer NF to enable the consumer NF to subsequently be subscribed to a resource provided by a particular producer NF;

FIG. 8 depicts exemplary operations, messages, and data flows associated with an exemplary process;

FIG. 9 illustrates an exemplary process for a producer NF to register itself, and the resource that the producer NF 105 offers to other NFs, with a Network Repository Function;

FIG. 10 depicts exemplary operations, messages, and data flows associated with an exemplary process;

FIGS. 11A-11C illustrate a first exemplary process for issuing an Access Token, and for authorizing a subscription for a consumer NF to a resource provided by a producer NF based on the issued Access Token;

FIGS. 12A-12C depict exemplary operations, messages, and data flows associated with an exemplary process;

FIGS. 13A-13D illustrate a second exemplary process for issuing an Access Token, and for authorizing a subscription for a consumer NF to a resource provided by a producer NF based on the issued Access Token; and

FIGS. 14A-14C depict exemplary operations, messages, and data flows associated with an exemplary process.

### DETAILED DESCRIPTION OF EXAMPLE EMBODIMENTS

The following detailed description refers to the accompanying drawings. The same reference numbers in different drawings may identify the same or similar elements. The following detailed description does not limit the invention.

In a network environment, such as a Fifth Generation (5G) mobile network environment, network functions (NFs) may subscribe to services or resources provided by other NFs. For example, a Session Management Function (SMF) in the mobile network may subscribe to policy updates for a particular session from a Policy Control Function (PCF). In this example, the SMF acts as the consumer NF that seeks to receive policy updates from the PCF, which in turn acts as the producer NF. Subsequent to successfully subscribing, the PCF would send the requested policy updates to the SMF at appropriate times. Other NFs within a 5G mobile network, such as, for example, Access and Mobility Management Functions (AMFs), Unified Data Management (UDM) functions, and User Plane Functions (UPFs), may subscribe to services or resources provided by different NFs within the mobile network.

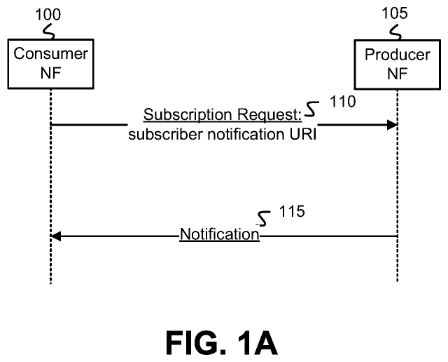

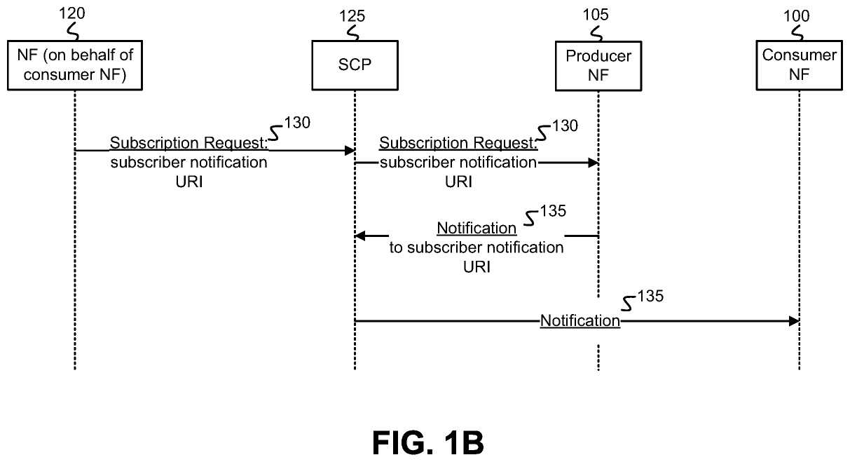

FIGS. 1A and 1B depict two typical scenarios in which a consumer NF 100 subscribes, or is subscribed by another entity, to resource of a producer NF 105 so as to receive content and/or notifications related to the subscription from the producer NF 105. A “resource” of a producer NF 105, as described herein, refers to a service provided by the producer NF 105 and/or data content supplied by the producer NF 105. A “service,” as described herein, refers to a composition of network functions executed by a producer NF 105, that may be defined by a functional and behavioral specification, and which further provide particular service-related information to other entities (e.g., to a subscribing consumer NF 100). FIG. 1A illustrates a first scenario in which a consumer NF 100 itself subscribes to a resource of a producer NF 105 to receive subscription content and/or notifications from the producer NF 105. In this scenario, a consumer 110 sends a subscription request 110 to the producer NF 105. The subscription request 110 includes a network address or domain name (e.g., a fully qualified domain name (FQDN)) associated with the consumer NF 100 and/or a Uniform Resource Identifier (URI) of the consumer NF 100 to which notifications and/or content associated with the resource should be delivered. In some implementations, the URI of the consumer NF 100 may include a Uniform Resource Locator (URL) of the consumer NF 100 to which the content and/or notifications associated with the resource should be sent. Upon receipt of the subscription request 110, the producer NF 105 enrolls the consumer NF 100 in a subscription to the resource and stores the subscriber notification URI associated with the consumer NF 100. The producer NF 105 may subsequently (e.g., upon the occurrence of an appropriate triggering event) send a notification 115 related to the resource to the resource-subscribed consumer NF 100.

FIG. 1B depicts a second scenario in which another entity, such as a NF 120, initiates, on behalf of a consumer NF 100, a subscription process for subscribing the consumer NF 100 to a resource offered by a producer NF 105. The NF 120, on behalf of the consumer NF 100, sends a subscription request 130 to a producer NF 105 that includes, among other data, the notification URI associated with the consumer NF 100. The notification URI, referred to herein as the “subscriber notification URI,” may include a Uniform Resource Locator (URL) of the consumer NF 100 to which the content and/or notifications associated with the resource may be sent. An intermediate Service Communication Proxy (SCP) 125 may receive and route the subscription request 130 to the producer NF 105 that offers the particular network resource. Upon receipt of the subscription request 130, the producer NF 105 enrolls the consumer NF 100 in a subscription to the network resource and stores the subscriber notification URI associated with the consumer NF 100. The producer NF 105 may subsequently (e.g., upon the occurrence of an appropriate triggering event) send a notification 135 related to the resource to the resource-subscribed consumer NF 100. The SCP 125 may route the notification 135 from the producer NF 105 to the destination consumer NF 100.

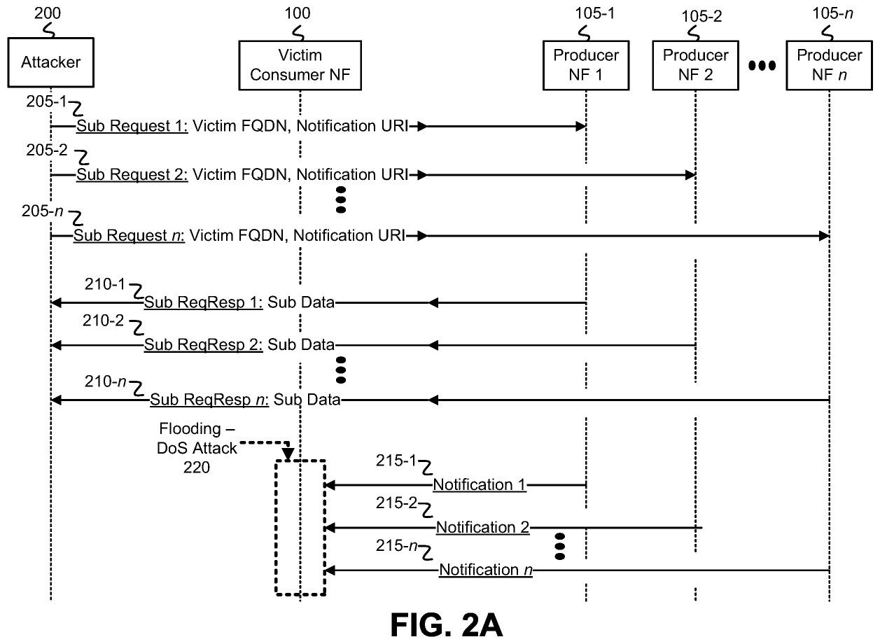

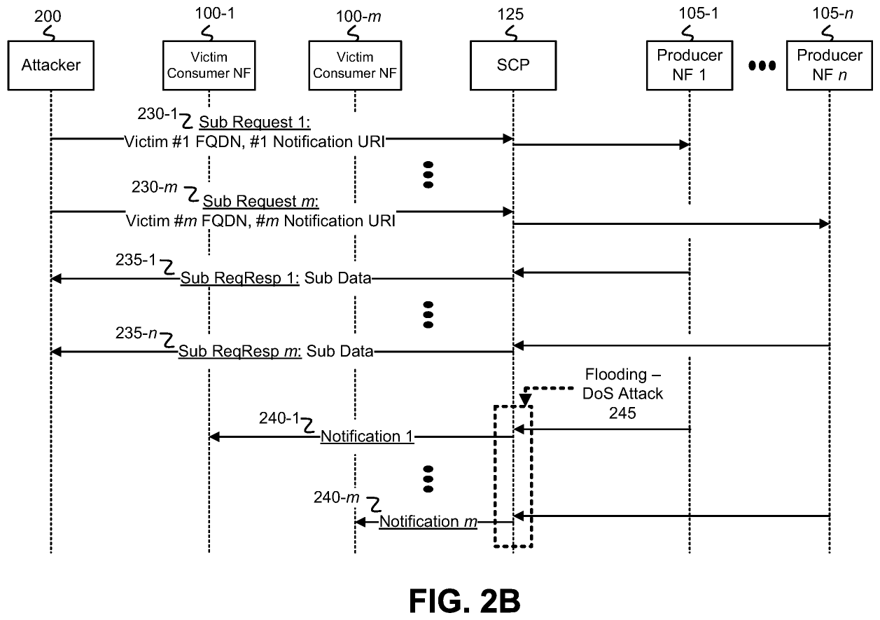

In some circumstances, a misconfiguration of a NF may occur such that the NF inadvertently sends subscription requests on behalf of another NF. In other circumstances, an entity (e.g., NF 120) acting to subscribe another NF (e.g., consumer NF 100) to a resource offered by a producer NF 105 may act intentionally to cause the consumer NF 100 to be flooded with content or notifications. FIG. 2A illustrates a first scenario in which an attacker may exploit the resource subscription process to cause denial of service (DoS) attacks at a victim consumer NF 100. As shown in FIG. 2A, an attacker 200, with knowledge of the notification URI associated with a victim consumer NF 100 in a network, sends multiple subscription requests, to n different producer NFs 105-1 through 105-n, that each include a same notification URI associated with the victim consumer NF 100. For example, as shown, attacker 200 sends a first subscription request 205-1 to producer NF 105-1 that includes the victim consumer NF 100's FQDN and the notification URI associated with the victim consumer NF 100. The attacker 200 further sends a second subscription request 205-2 to producer NF 105-2 that includes the victim consumer NF 100's FQDN and notification URI. The attacker 200 additionally sends an nth subscription request 205-n to producer NF 105-n that includes the victim consumer NF 100's FQDN and notification URI.

Upon receipt of subscription request 205-1, producer NF 105-1 enrolls the victim consumer NF 100's FQDN in a resource subscription and stores the FQDN and notification URI for resource-related notifications. Producer NF 105-1 returns a subscription request response 210-1 to attacker 200 that indicates that the subscription process was successful for the particular victim consumer NF 100. Producer NF 105-2, upon receipt of subscription request 205-2, enrolls the victim consumer NF 100's FQDN in a resource subscription and stores the FQDN and notification URI for resource-related notifications. Producer NF 105-2 returns a subscription request response 210-2 to attacker 200 that indicates that the subscription process was successful for the particular victim consumer NF 100. Producer NF 105-n, upon receipt of subscription request 205-n, enrolls the victim consumer NF 100's FQDN in a resource subscription and stores the FQDN and notification URI for resource-related notifications. Producer NF 105-n returns a subscription request response 210-n to attacker 200 that indicates that the subscription process was successful for the particular victim consumer NF 100.

Subsequently, producer NFs 105-1 through 105-n may send numerous notifications 215-1 through 215-n to the notification URI provided by the attacker 200 in the subscription requests 205-1 through 205-n resulting in a flood of notification messages being received at victim consumer NF 100. The flooding 220 of notification messages 215 at victim consumer NF 100 may overload the consumer NF 100 causing a DoS to other messages destined to victim consumer NF 100.

FIG. 2B illustrates a second scenario in which an attacker 200 may exploit the resource subscription process to cause DoS attacks at a SCP 125 involved in routing data units from producer NFs to victim consumer NFs 100. As shown in FIG. 2B, an attacker 200, having knowledge of the notification URI associated with a first victim consumer NF 100-1, sends a first subscription request 230-1 to a first producer NF 105-1 that includes the victim consumer NF 100-1's notification URI. An intermediate SCP 125 receives the subscription request 230-1 and routes the request to the destination producer NF 105-1. In the example shown, the subscription request 230-1 to producer NF 105-1 may include victim consumer NF 100-1's FQDN and the notification URI associated with the victim consumer NF 100-1. Furthermore, the attacker 200, having knowledge of the notification URI associated with an mth victim consumer NF 100-m (where m is greater than or equal to two), sends an mth subscription request 230-m to an mth producer NF 105-m that includes the victim consumer NF 100-m's notification URI. The intermediate SCP 125 receives the subscription request 230-m and routes the request to the destination producer NF 105-n. In the example shown, the subscription request 230-m to producer NF 105-n may include victim consumer NF 100-m's FQDN and the notification URI associated with the victim consumer NF 100-m.

Upon receipt of subscription request 230-1, producer NF 105-1 enrolls the victim consumer NF 100-1's FQDN in a resource subscription and stores the FQDN and notification URI for resource-related notifications. Producer NF 105-1 returns a subscription request response 235-1 to attacker 200 that indicates that the subscription process was successful for the particular victim consumer NF 100-1. The intermediate SCP 125 receives the subscription request response 235-1 and routes the response to the attacker 200. Producer NF 105-n, upon receipt of subscription request 230-m, enrolls the victim consumer NF 100-2's FQDN in a resource subscription and stores the FQDN and notification URI for resource-related notifications. Producer NF 105-n returns a subscription request response 235-m to attacker 200 that indicates that the subscription process was successful for the particular victim consumer NF 100-m. The intermediate SCP 125 receives the subscription request response 235-m and routes the response to the attacker 200.

Subsequently, producer NFs 105-1 and 105-n may send numerous notifications 240-1 through 240-m to the notification URI of the victim consumer NF 100-1 and to the notification URI of the victim consumer NF 100-m via a same intermediate SCP 125. The numerous notifications 240 result in a flood of notification messages being received at the SCP 125 for routing to victim consumer NFs 100-1 and 100-m. The flooding 245 of notification messages 240 at SCP 125 may overload the SCP 125 causing a DoS to other messages from other NFs destined for routing by SCP 125. The flooding 245 of notification messages may, therefore, significantly impact traffic to and from other NFs that is being routed by the SCP 125 which is undergoing the DoS attack.

Current resource subscription processes for NFs do not include explicit authorization mechanisms at the producer NF to validate the subscription requests before subscribing a consumer NF to the resource and subsequently sending subscription content and/or notifications to the consumer NF. Current resource subscription processes permit create, read, update, and delete types of operations related to subscribing to a producer NF's resources to be performed by unauthorized, and potentially malicious, NFs on behalf of other victim NFs, causing, in certain circumstances, DoS attacks at the victim NFs and/or at the SCPs that route messages to the victim NFs.

Exemplary implementations described herein incorporate authorization and validation mechanisms into the NF resource subscription process to attempt to prevent unauthorized, and potentially malicious, NFs from subscribing to a NF resource, or prevent NFs improperly acting on behalf of and/or impersonating other NFs, to subscribe those other NFs to a NF resource. In a first authorization technique described herein, a Network Repository Function (NRF) acts as a notary and certifies and notarizes a notification URI to which subscription content and/or notifications are sent to a consumer NF. The notarized URI may then be used as part of an authorization and validation process to approve or deny a subscription request for a particular consumer NF. In a second authorization technique described herein, the NRF adds new fields to the payload of the Access Token used to authorize a NF for requesting a NF subscription. The new Access Token payload fields include a type of service field, a resource ID field, and a notification URI field. The NRF digitally signs the Access Token and thereby provides integrity and authenticity to the newly added type of service, resource ID, and notification URI fields of the Access Token. The resulting NRF digital signature, when verified and the new payload fields extracted, may then be used as part of an authorization and validation process to approve or deny a subscription request for a particular consumer NF. Incorporation of the authorization and validation mechanisms described herein within the NF resource subscription process protects producer NFs, and the SCPs that route messages to/from consumer NFs and producer NFs, from mis-behaving NFs or from NFs (or other network entities) impersonating legitimate NFs, that may unintentionally or intentionally cause flooding and possibly denial of service attacks at consumer NFs and/or SCPs.

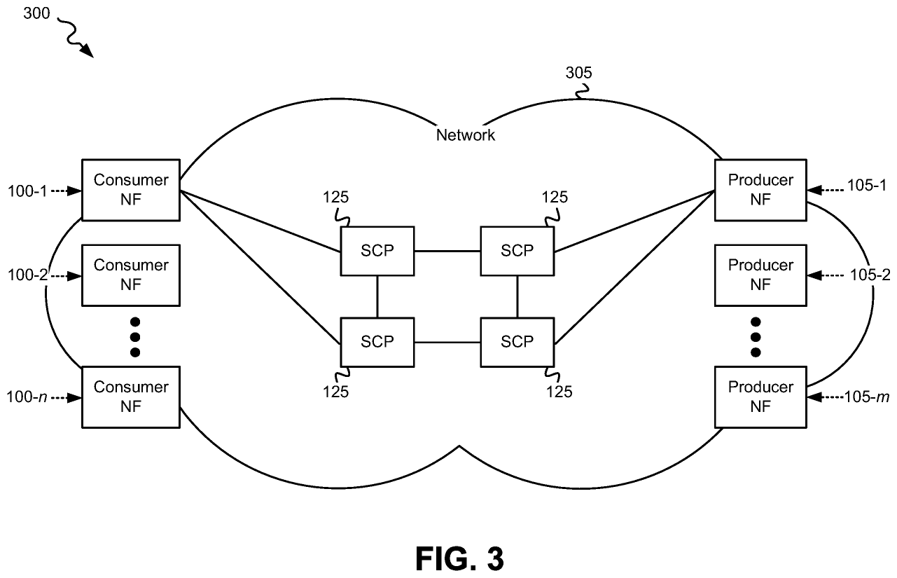

FIG. 3 depicts an exemplary network environment 100 in which NFs may subscribe to resources provided by other NFs. As shown, network environment 300 includes consumer network functions (NFs) 100-1 through 100-n (where n is any integer greater than or equal to one), producer NFs 105-1 through 105-m (where m is any integer greater than or equal to one), and a network 305.

Each of consumer NFs 100-1 through 100-n (generically referred to herein as “consumer NF 100” or “consumer NFs 100”) includes a Virtual Network Function (VNF) instance that may request a resource from one of producer NFs 105-1 through 105-m (generically referred to herein as “producer NF 105” or “producer NFs 105”). Consumer NFs 100 may include multiple, different VNF instances, or may include one or more groups of VNF instances that are equivalent to one another and can be used interchangeably. A consumer NF 100 may, in certain circumstances, also act as a producer NF 105. The VNF instances of consumer NFs 100 may be installed and executed at one or more network devices (not shown) within, or connected to, network 305. The VNF instances of consumer NFs 100 may, therefore, be distributed across multiple network devices within, or connected to, network 305.

Each of producer NFs 105 includes an instance of VNF that may receive requests for a resource from at least one of consumer NFs 100 and may supply content and/or notifications associated with the requested resource to the requesting consumer NF 100 or to another consumer NF 100. Producer NFs 105 may include multiple, different VNF instances, or may include one or more groups of VNF instances that are equivalent to one another and can be used interchangeably. A producer NF 105 may, in certain circumstances, also act as a consumer NF 100. The VNF instances of producer NFs 105 may be installed and executed at one or more network devices within, or connected to, network 305. The VNF instances of producer NFs 105 may, therefore, be distributed across multiple network devices within, or connected to, network 305.

Network 305 may include one or more networks of various types including, for example, a Public Switched Telephone Network (PSTN), a wireless network, a LAN, a wide area network (WAN), a metropolitan area network (MAN), an intranet, or the Internet. The wireless network may include a satellite network, a Public Land Mobile Network (PLMN), and/or a wireless LAN or WAN (e.g., Wi-Fi). As shown, network 305 may include one or more Service Communication Proxies (SCPs) 125. Each SCP 125 includes a specialized NF that can route messages between consumer NFs 100 and producer NFs 105.

The configuration of components of network environment 300 in FIG. 3 is for illustrative purposes. Other configurations may be implemented. Therefore, network environment 300 may include additional, fewer and/or different components that may be configured in a different arrangement from that depicted in FIG. 3.

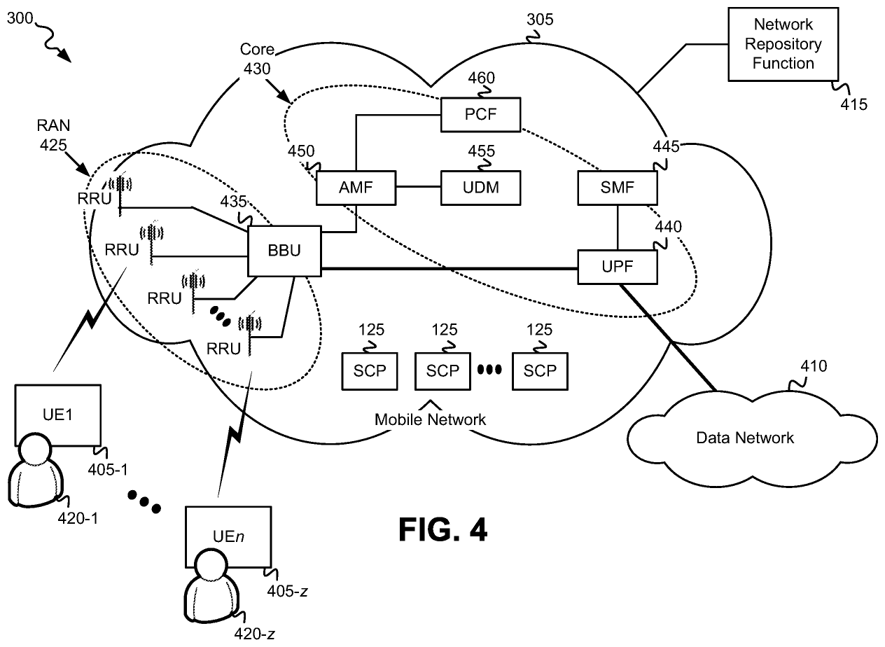

FIG. 4 depicts an example of the network environment 300 of FIG. 3 in which network 305 includes a PLMN (referred to herein as a “mobile network”). As shown, the example network environment 300 may include user equipment devices (UEs) 405-1 through 405-z, mobile network 305, a data network 410, and a network repository function (NRF) 415.

UEs 405-1 through 405-z (generically referred to herein as a “UE 405” or “UEs 405”) may each include any type of device having a wireless communication capability. UEs 405 may include, for example, a laptop, palmtop, wearable, or tablet computer; a cellular phone (e.g., a “smart” phone); a Voice over Internet Protocol (VoIP) phone; an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user may carry, use, administer, and/or operate each UE 405. A user 420-1 is shown in association with UE 405-1 and a user 420-n is shown in association with UE 405-n.

Mobile network 305 may include a Radio Access Network (RAN) 425 and a core network 430. RAN 425 may include various types of radio access equipment that implement Radio Frequency (RF) communication with UEs 405. The radio access equipment of RAN 425 may include, for example, multiple Remote Radio Units (RRUs) and at least one baseband unit (BBU) 435 (only a single BBU 435 is shown in FIG. 4, however, RAN 425 may include multiple BBUs). Each of the RRUs includes a device(s) that operates as a radio function unit which transmits and receives RF signals to/from UEs 405. BBU 435 interconnects with the distributed RRUs of RAN 425 via fronthaul links or a fronthaul network. RAN 425 may additionally include other nodes, functions, and/or components not shown in FIG. 4.

Core network 430 includes devices or nodes that perform network functions that operate the mobile network 305 including, among other network functions, mobile network access management, session management, and policy control. In the example network environment 300 of FIG. 4, core network 430 is shown as including a Fifth Generation (5G) mobile network that further includes 5G NFs, such as a User Plane Function (UPF) 440, a Session Management Function (SMF) 445, an Access and Mobility Management Function (AMF) 450, a Unified Data Management (UDM) function 455, and a Policy Control Function (PCF) 460. UPF 440, SMF 445, AMF 450, UDM 455, and PCF 460 may be implemented as VNFs within mobile network 305 and may operate as the consumer NFs 100 and/or producer NFs 105 depicted in FIG. 3.

UPF 440 acts as a router and a gateway between mobile network 305 and data network 410, and forwards session data between data network 410 and RAN 425. Though only a single UPF 440 is shown in FIG. 4, mobile network 305 may include multiple UPFs 440 at various locations in network 305. SMF 445 performs session management, allocates network addresses to UEs 405, and selects and controls UPFs 440 for data transfer. AMF 450 performs authentication, authorization, and mobility management for UEs 405. UDM 455 manages data for user access authorization, user registration, and data network profiles. UDM 455 may include, or operate in conjunction with, a User Data Repository (UDR—not shown) which stores user data, such as customer profile information, customer authentication information, and encryption keys. PCF 460 implements policy and charging control for service data flows and Protocol Data Unit (PDU) session related policy control.

Data network 410 may include one or more interconnected networks, such as local area networks (LANs), wide area networks (WANs), metropolitan area networks (MANs), and/or the Internet. Data network 410 connects with UPF 440 of the core network 430 of mobile network 305.

NRF 415 includes one or more network devices that connect to mobile network 305 and operates as a centralized repository of information regarding NFs in mobile network 305. NRF 415 enables NFs (e.g., UPF 440, SMF 445, AMF 450) to register and discover each other via an Application Programming interface (API). NRF 415 maintains an updated repository of information about the NFs available in mobile network 305, along with information about the services provided by each of the NFs. NRF 415 further enables the NFs to obtain updated status information of other NFs in mobile network 305. NRF 415 may, for example, maintain profiles of available NF instances and their supported services, allow NF instances to discover other NF instances in mobile network 305, and allow NF instances to track the status of other NF instances. In some implementations, NRF 415 may be a virtual entity implemented by one or more devices within mobile network 305, such as a device implementing AMF 450, a device implementing SMF 445, and/or a device implementing 4CF 260.

As shown in FIG. 4, mobile network 415 may include the SCPs 125 described above with respect to FIG. 3. Each of the NFs UPF 240, SMF 245, AMF 250, UDM 255, and PCF 260 may act as a consumer NF 100 and/or a producer NF 105 described above with respect to FIG. 3. For example, AMF 450 may act as a consumer NF instance 100 that requests policy information from PCF 460, which further acts as a producer NF 105 when supplying the policy information to AMF 450. Each of the NFs acting as a consumer NF 100 may communicate via one or more SCPs 125 that operate to route messages to a target producer NF 105.

The configuration of network components of the example network environment 300 of FIG. 4 is for illustrative purposes. Other configurations may be implemented. Therefore, network environment 300 may include additional, fewer, and/or different components that may be configured in a different arrangement than that depicted in FIG. 4. For example, core network 430 may include other NFs not shown in FIG. 4. As a further example, though mobile network 305 is depicted in FIG. 4 as a 5G network having 5G network components/functions, mobile network 305 may alternatively include a 4G or 4.5G network with corresponding network components/functions, or a hybrid 5G/4G network that includes certain components of both a Next Generation network (e.g., a 5G network) and a 4G network. As another example, though NRF 415 is shown in FIG. 4 as being connected to mobile network 305, in alternative implementations NRF 415 may instead connect to data network 410.

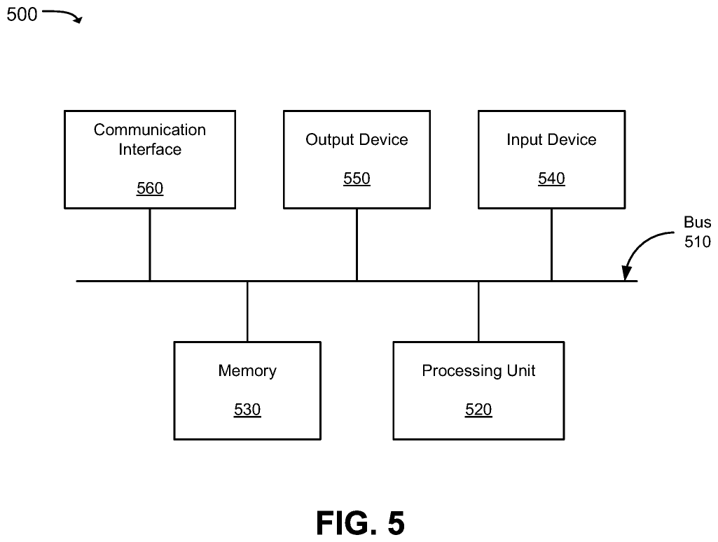

FIG. 5 is a diagram that depicts exemplary components of a device 500. UEs 405, the RRUs of RAN 425, BBU 435, and NRF 415 may include components that are the same as, or similar to, those of device 500 shown in FIG. 5. Furthermore, each of the network functions UPF 440, SMF 445, AMF 450, UDM 455 and PCF 460 of core network 435 may be implemented by a network device that includes components that are the same as, or similar to, those of device 500. Some of the NFs UPF 440, SMF 445, AMF 450, UDM 455 and/or PCF 460 may be implemented by a same device 500 within mobile network 305, while others of the functions may be implemented by one or more separate devices 500 within mobile network 305.

Device 500 may include a bus 510, a processing unit 520, a memory 530, an input device 540, an output device 550, and a communication interface 560. Bus 510 may include a path that permits communication among the components of device 500. Processing unit 520 may include one or more processors or microprocessors, or processing logic, which may interpret and execute instructions. Memory 530 may include one or more memory devices for storing data and instructions. Memory 530 may include a random access memory (RAM) or another type of dynamic storage device that may store information and instructions for execution by processing unit 520, a Read Only Memory (ROM) device or another type of static storage device that may store static information and instructions for use by processing unit 520, and/or a magnetic, optical, or flash memory recording and storage medium. The memory devices of memory 530 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 530 for execution by processing unit 520.

Input device 540 may include one or more mechanisms that permit an operator to input information into device 500, such as, for example, a keypad or a keyboard, a display with a touch sensitive panel, voice recognition and/or biometric mechanisms, etc. Output device 550 may include one or more mechanisms that output information to the operator, including a display, a speaker, etc. Input device 540 and output device 550 may, in some implementations, be implemented as a user interface (UI) that displays UI information and which receives user input via the UI. Communication interface 560 may include a transceiver(s) that enables device 500 to communicate with other devices and/or systems. For example, communication interface 560 may include one or more wired and/or wireless transceivers for communicating via mobile network 305 and/or data network 410. In the case of RRUs of RAN 425, communication interface 560 may further include one or more antenna arrays for producing radio frequency (RF) cell sectors.

The configuration of components of device 500 illustrated in FIG. 5 is for illustrative purposes. Other configurations may be implemented. Therefore, device 500 may include additional, fewer and/or different components than those depicted in FIG. 5.

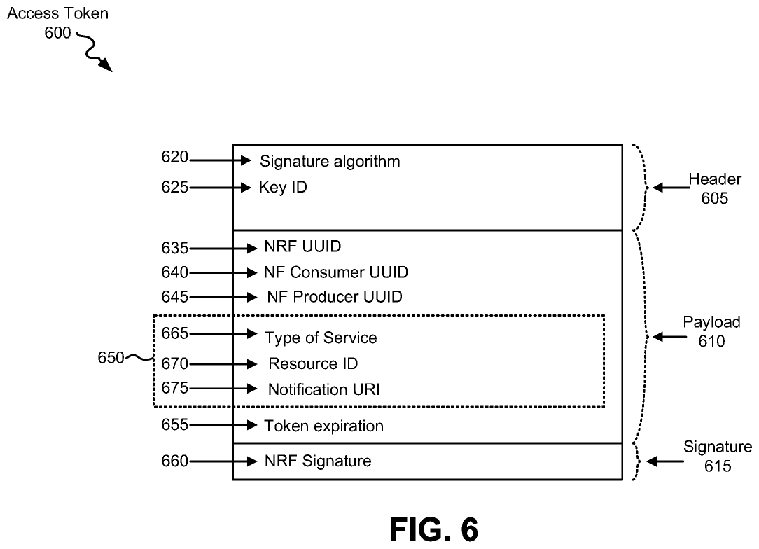

FIG. 6 illustrates an exemplary access token 600 that may be used for enabling token-based authorization to a resource of a producer NF 105. In the example network environment 300 of FIG. 3, in which network 305 includes a mobile network, Access Token 600 may be issued by NRF 415 to a consumer NF 100 for use in subscribing to a resource of a producer NF 105. Access token 600 may, thus, be sent between NRF 415 and consumer NFs 100, and between consumer NFs 100 and producer NFs 105 (e.g., between SMF 245, AMF 250, UDM 255, PCF 260, and/or SCP 130), within, for example, Control Plane (CP) messaging. In one implementation, Access Token 600 may be an Open Authorization (OAuth) access token used as a component of an open standard authorization framework for token-based authorization. For example, Access Token 600 may be an OAuth token that is based on the OAuth 2.0 framework specified in Internet Engineering Task Force (IETF) Request for Comments (RFC) 6749. As an OAuth 2.0 access token, Access Token 600 may be generated as a JavaScript Objection Notation (JSON) Web Token based on IETF RFC 7519, and the signed access token may be generated based on the JSON Web Signature (JWS) specification described in IETF RFC 7515.

Header 605 may include a signature algorithm field 620 and a key ID field 625. Payload 610 may include a NRF Universally Unique Identifier (UUID) field 635, a NF consumer UUID field 640, a NF producer UUI field 645, optional payload fields 650, and a token expiration field 655. Signature 615 includes a signature field 660. As an alternative to use of UUIDs, other IDs (e.g., FQDNs) for uniquely identifying NRF 415, consumer NFs 100, and/or producer NFs 105 may be used.

Signature algorithm field 620 identifies a digital signature algorithm that may be used to integrity protect a portion of the access token 600, such as, for example, the payload 610, to generate an Access Token signature. The signature algorithm may include, for example, HS256 algorithm, ES256 algorithm, Digital Signature Algorithm (DSA), Elliptic Curve Digital Signature Algorithm (ECDSA), Edwards curve Digital Signature Algorithm (EdDSA), Rivest-Shamir-Adleman (RSA) algorithm, ElGamal signature algorithm, or Schnorr digital signature algorithm. Other types of signature algorithms not described herein may be alternatively used.

Key ID field 625 identifies the key to be used with the signature algorithm identified in field 620 to provide integrity and authenticity to the portion of the access token 600 and generate the Access Token signature. Key ID field 625 identifies the particular public key (e.g., RSA, Elliptic Curve) to be used.

NRF UUID field 635 includes a UUID for the NRF 415 that is the issuer of the Access Token 600. In some implementations, the UUID may be replaced by a network address (e.g., a FQDN, or IP address) for the NRF 415.

NF consumer UUID field 640 includes a UUID for the consumer NF for whom the Access Token 600 is being issued. The consumer NF identified in field 640 may use the access token 600 for requesting a subscription from the NF producer identified in field 645. NF producer UUID field 645 includes a UUID for the producer NF that offers a resource for which the access token 600 is issued to enable a subscription to be requested for the consumer NF identified in field 640.

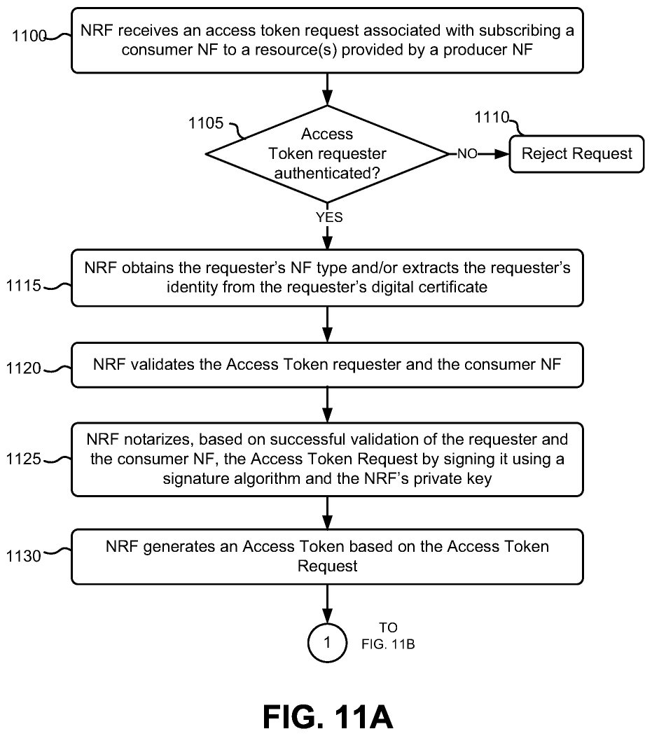

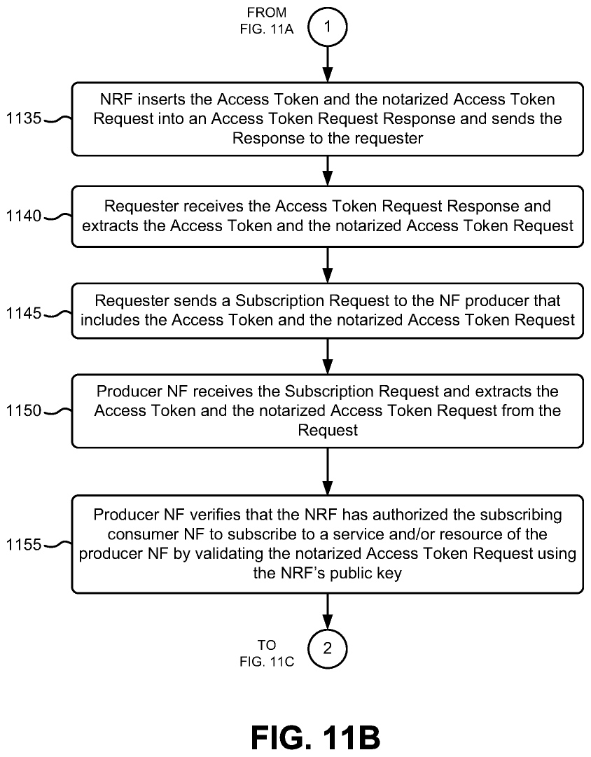

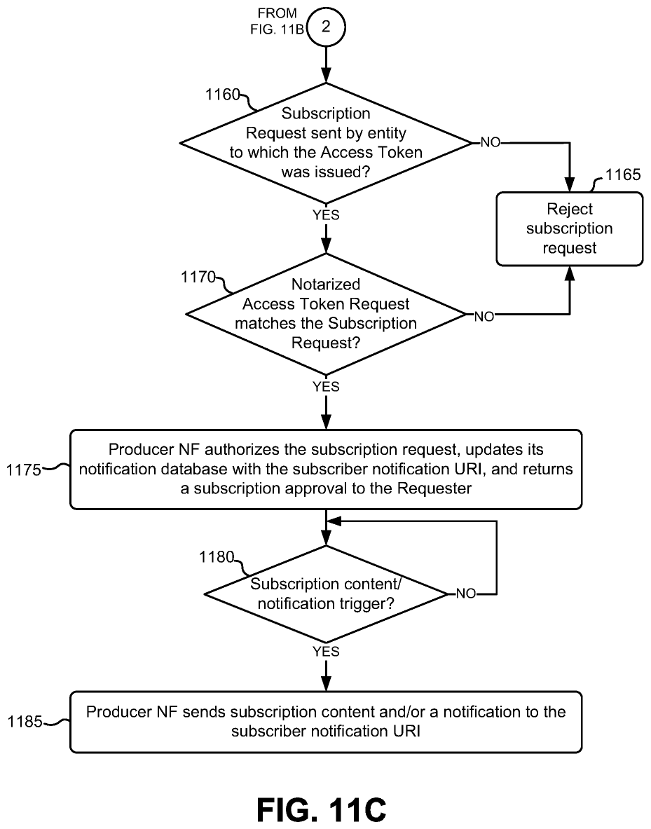

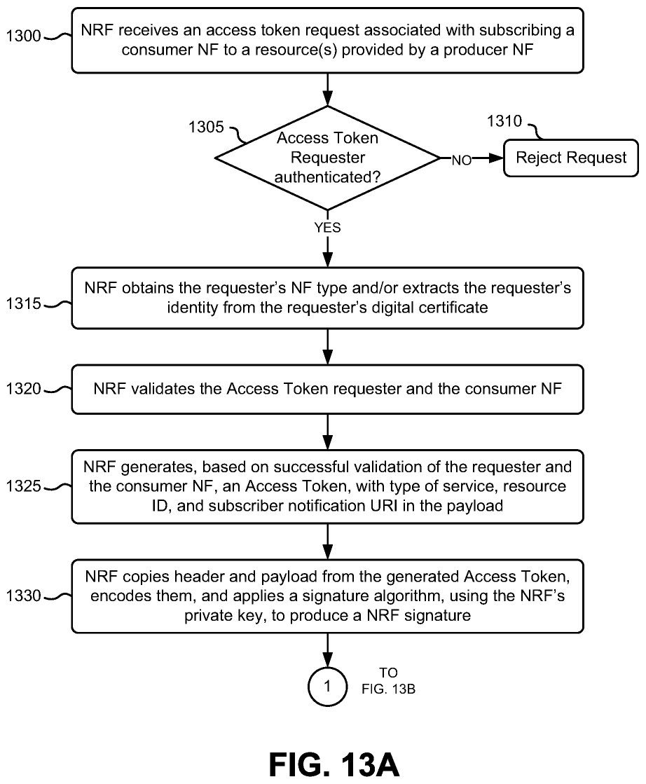

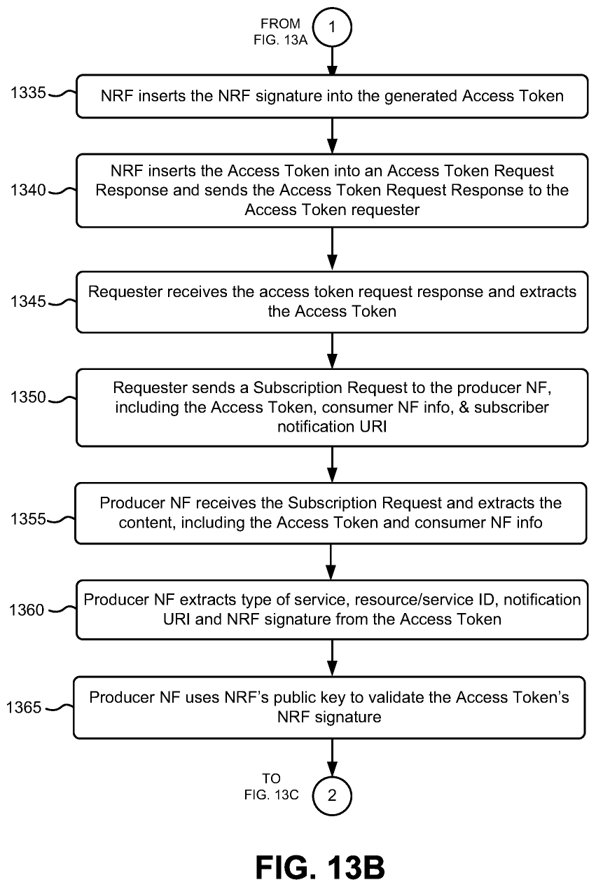

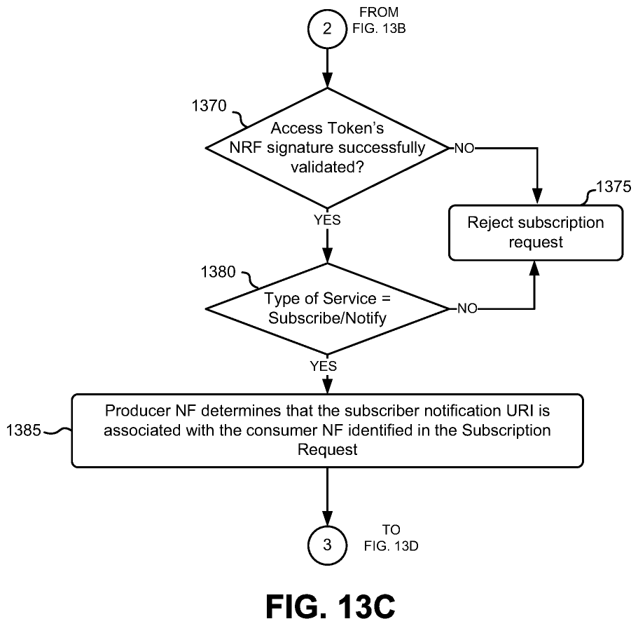

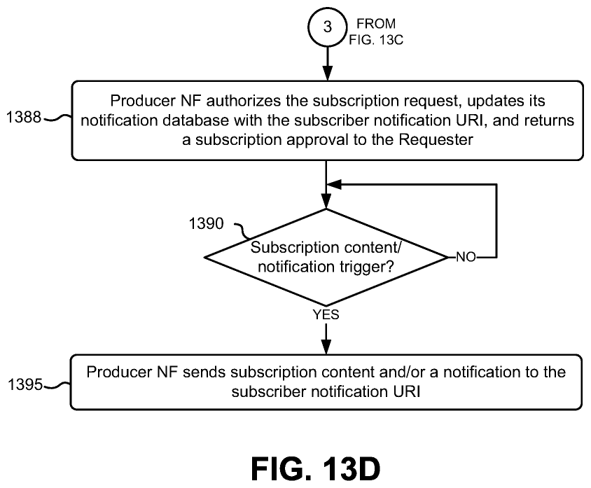

Optional payload fields 650 may include a type of service field 665, a resource ID field 670, and a notification URI field 675. Optional payload fields 650 may be included in the Access Token 600 used in the exemplary process described with respect to FIGS. 13A-13D below, and may be omitted from the Access Token 600 used in the exemplary process described with respect to FIGS. 11A-11C below. Type of service field 665 identifies a type of service for which the Access Token 600 is being issued. The type of service field 665 may, for example, identify a subscribe-notification service, a content delivery service, etc. Other types of network services may be identified in field 665. Resource ID field 670 identifies a particular resource, associated with the producer NF identified in field 645, that is to be requested for use by the consumer NF identified in field 640. Notification URI field 675 includes the URI, associated with the consumer NF identified in field 640, to which notifications, contents, etc. associated with the resource identified in field 670 should be sent. The Notification URI field 675 may alternatively include a URI that is associated with a consumer NF, that is different from the consumer NF identified in field 640, and to which notifications, content, etc. associated with the resource identified in field 670 should be sent.

Token expiration field 655 identifies a time at which the content contained in access token 600 expires. The time may include a particular month, day, and year at which the access token 600 expires. Alternatively, field 665 may identify a time period (e.g., x milliseconds, seconds, minutes, hours, days, etc.) at the end of which access token 600 expires.

Signature field 660 stores the digital signature generated by the NRF 415 identified in 635 using the signature algorithm identified in field 620 and the key identified in field 625.

Access token 600 of FIG. 6 is depicted as including a certain number of sections and fields having a certain content. However, the number, types, and content of the sections and fields in the access token 600 in FIG. 6 are for illustrative purposes. Access token 600 may have a different number of, types of, and/or content of, sections and/or fields than those illustrated in FIG. 6.

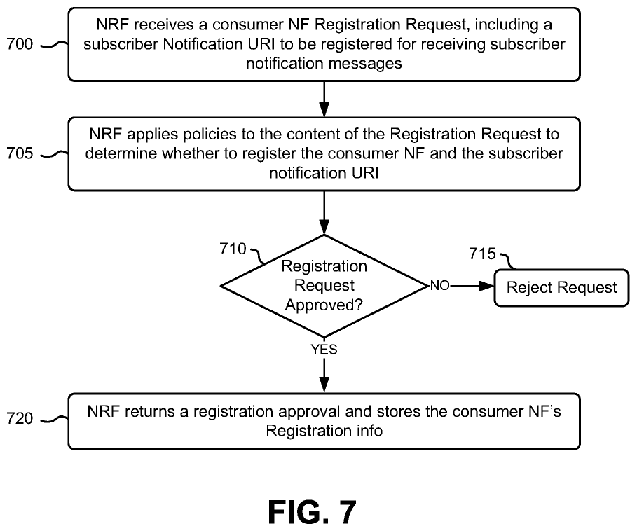

FIG. 7 illustrates an exemplary process for registering a consumer NF 100 to enable the consumer NF to subsequently be subscribed to a resource provided by a particular producer NF 105. The exemplary process of FIG. 7 may be implemented by a NRF 415, in conjunction with a consumer NF 100, or other entity acting on behalf of the consumer NF 100.

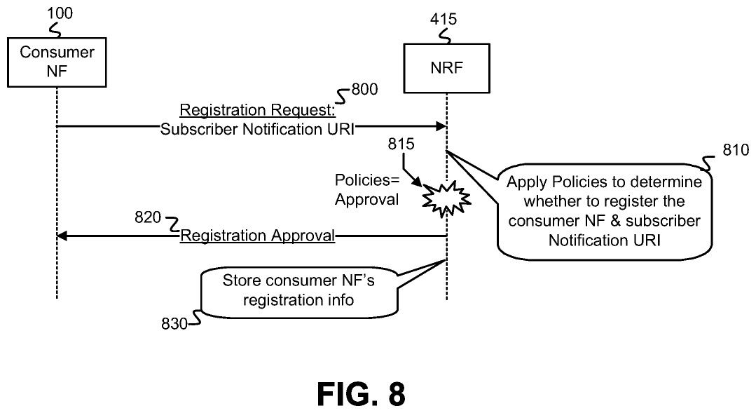

The exemplary process includes NRF 415 receiving a consumer NF registration request, including a subscriber notification URI to be registered for receiving subscriber content and/or subscriber notification messages (block 700). The subscriber notification URI (e.g., FQDN) may belong to a different consumer NF than the one that is performing the NF registration request. The consumer NF 100 itself, or an entity (e.g., a network administrator) acting on behalf of the consumer NF 100, may generate a Registration Request that includes information about the consumer NF 100 (e.g., NF type, NF UUID, etc.), an identification of the resource needed for the subscription, a length of time the identified resource is needed, and data identifying the subscriber notification URI at which the consumer NF 100 is to receive messages containing content and/or notifications. FIG. 8 shows a consumer NF 100 sending a Registration Request 800 that includes, among other data, a subscriber notification URI at which the consumer NF 100 is to receive content and/or notification.

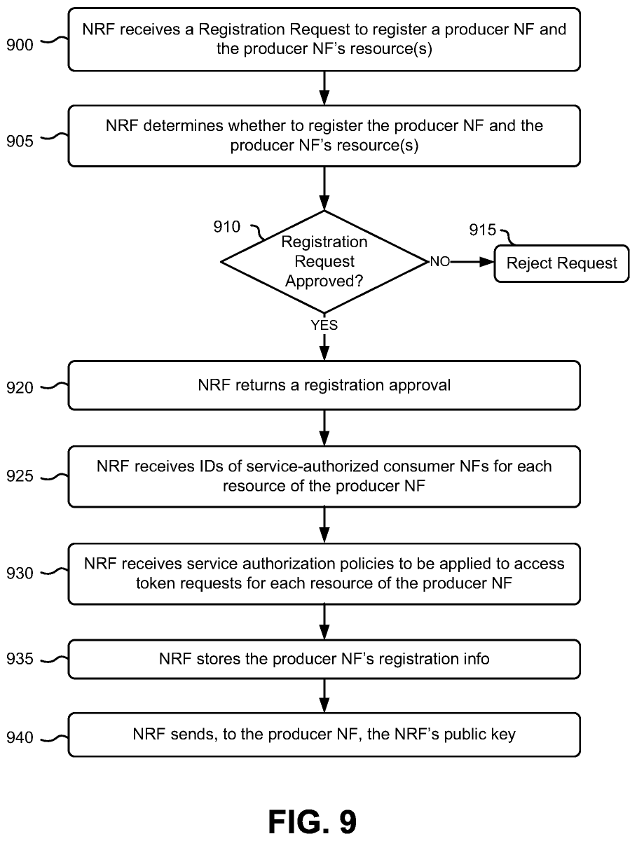

NRF 415 applies policies to the content of the Registration Request to determine whether to register the consumer NF 100 and the subscriber notification URI (block 705). NRF 415 may store a set of policies to be applied to the various data content contained in the Registration Requests to determine whether to approve those Registration Requests. The policies may include, for example, a set of rules that specify conditions, constraints, and/or settings that are applied to the content of the Registration Request, and possibly to other data associated with the received Registration Request, to determine whether to approve a particular Registration Request. For example, the policies may specify that only requests from particular NF types for a particular resource may be approved. As another example, the policies may specify that requests associated with particular notification URIs or particular NF addresses or IDs may be rejected. As an additional example, the NRF 415 may reject a Registration Request based on policies that determine that the Registration Request originates from an un-authenticated and/or un-authorized consumer NF 100 or from an un-authorized network administrator. At least a portion of the policies may, for example, be received when a given producer NF 105 is registered and the registration includes a NF profile that specifies restrictive policies to be applied to registration requests for consumer NFs 100 (as described with respect to block 900 of FIG. 9 below). FIG. 8 depicts NRF 415 applying 810 policies to determine whether to register the consumer NF 100 and the subscriber notification URI received in the Registration Request 800. As an alternative to the automated application of policies to Registration Requests by NRF 415, NRF 415, upon receipt of a Registration Request, may pass the Registration Request to a human for manual registration request review and approval. A result of the manual registration review and approval may be provided to the NRF 415 to complete the consumer NF registration process.

If the registration request is denied by NRF 415 (NO—block 715), then NRF 415 returns a rejection of the request to the node that originated the request (block 715). If the registration request is approved (YES—block 715), then NRF 415 returns a registration approval to the node that originated the request and stores the consumer NF's registration information (block 720). The NRF 415 may store the consumer NF 100's registration information in local memory, in a locally connected database, or in a remotely connected database. FIG. 8 shows NRF 415's application of the policies resulting in approval 815 of the Registration Request 800 from the consumer NF 100. As a consequence of the approval 815, NRF 415 returns a Registration Approval message 820 to consumer NF 100 and stores 830 the consumer NF 100's registration information. FIG. 9 illustrates an exemplary process for a producer NF 105 to register itself, and the resource that the producer NF 105 offers to other NFs, with NRF 415. The producer NF 105 registers itself such that NRF 415 may issue Access Tokens on the producer NF 105's behalf that a consumer NF 100, or other entity acting on the consumer NF 100's behalf, may request a subscription to the resource of the producer NF 105. The exemplary process of FIG. 9 may be implemented by NRF 415, in conjunction with a producer NF 105. The exemplary process of FIG. 9 may be executed when a NRF 415 receives a request to register a producer NF 105's resource with the NRF 415.

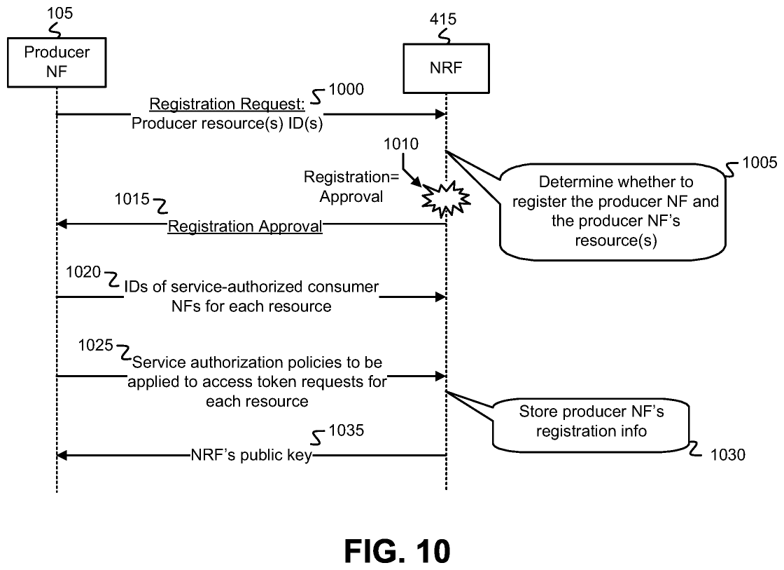

The exemplary process includes a NRF 415 receiving a registration request to register a producer NF 105 and the producer NF 105's resource (block 900). The producer NF 105 itself, or an entity (e.g., a network administrator) acting on behalf of the producer NF 105, may generate a Registration Request that includes information about the producer NF 100, including a UUID (e.g., a network address, a FQDN) of the producer NF 105 and an identification of the resource provided by the producer NF 105 to consumer NFs 100. The Registration Request may include other data that describes the producer NF 105 and/or the resource provided by the producer NF 105. For example, the Registration Request may additionally include a time period over which a particular resource is available to consumer NFs 100. In some implementations, the Registration Request sent to register a producer NF 105 may include a NF profile that specifies restrictions (e.g., restrictive policies) on which consumer NFs 100 may register and/or send notification URIs on their own behalf, or on behalf of other consumer NFs 100. FIG. 10 depicts an example of a producer NF 105 itself sending a Registration Request message 1000 that includes, among other data, an ID of the producer NF 105's resource that is being registered.

NRF 415 determines whether to register the producer NF 105 and the producer NF 105's resource (block 905). In one implementation, to determine whether to register the producer NF 105, NRF 415 may authenticate the connection with the producer NF 105 by using, for example, existing certificate-based authentication techniques. For example, the producer NF 105 and the NRF 415 may perform end-to-end authentication using X.509v3 digital certificates. FIG. 10 shows NRF 415 determining 1005 whether to register the producer NF 105 and the producer NF 105's resource.

If the producer NF registration is denied (NO—block 910), then NRF 415 returns a rejection of the registration request (block 915). If the producer NF registration is approved (YES—block 910), then NRF 415 returns, to the requesting producer NF 105, a registration approval message (block 920). FIG. 10 shows NRF 415's registration determination 1005 resulting in a registration approval 1010. As further shown, as a consequence of the approval 1010 of the producer NF 105's Registration Request 1000, NRF 415 returns a Registration Approval 1015 to the producer NF 105.

NRF 415 receives IDs of service-authorized consumer NFs for each resource of the producer NF 105 (block 925). The producer NF 105 may have a list of the IDs of consumer NFs 100 that are authorized to subscribe to each resource offered by the producer NF 105. The producer NF 105 may, as shown in FIG. 10, send a message 1020 to the NRF 415 that includes a list of the IDs of the service-authorized consumer NFs 100 for each resource offered by the producer NF 105. Alternatively, another entity, such as, for example, a network administrator, may provide the list of the IDs of the consumer NFs 100 to NRF 415 that are authorized to subscribe to each resource offered by the producer NF 105. As an alternative to block 925 above, NRF 415 may receive a list of NF-types (e.g., from a producer NF 105) that are authorized to subscribe to each resource offered by a producer NF 105. The NF-type describes a type or class of the NF instance (e.g., a consumer NF instance). Multiple instances of a same NF (having a same binary code and same configuration), that may be instantiated for load balancing, geo-redundancy, etc., may have a same NF-type. In some implementations, the information included messages 1020 and/or 1025 shown in FIG. 10 may instead be included within the Registration Request message 1000.

NRF 415 receives service authorization policies to be applied to access token requests for each resource of the producer NF 105 (block 930). The service authorization policies may include rules that specify the conditions, constraints, and/or settings that are to be applied to Access Token Requests received at NRF 415 for a particular resource offered by the producer NF 105. For example, a producer NF 105 may supply a NF profile to NRF 415 that specifies restrictions on which consumer NFs 100 may send Access Token requests. Alternatively, another entity, such as, for example, a network administrator, may provide the service authorization policies to be applied to access token requests for each of the producer NF 105's resources. As shown in FIG. 10, the producer NF 105 may send a message 1025 that includes service authorization policies for each of the producer NF 105's resources.

NRF 415 stores the producer NF 105's registration information (block 935), and sends, to the producer NF 105, the NRF 415's public key (block 940). NRF 415 stores the producer NF-related data contained in the Registration Request received in block 1000, the service-authorized consumer NF IDs received in block 930, and/or the service-authorization policies received in block 930. NRF 415 may store the data in association with a UUID (or any other ID, such as a FQDN that can be used to map to a UUID) of the producer NF 105 and an ID(s) of the resource. The public key may be a component of the NRF 415's public/private key pair for use in any asymmetric encryption algorithm, such as an asymmetric digital signature algorithm that may be used for Access Token signature generation. FIG. 10 depicts NRF 415 storing 1030 the producer NF 105's registration information, and sending a message 1035 that includes the NRF's public key (for use during Access Token signature generation) to the producer NF 105 that originated the Registration Request 1000. In some implementations, block 940 may be optional, and may be omitted from the process of FIG. 9. When block 940 is included in the process of FIG. 9, the NRF 415 may provision the producer NF 105 with the NRF 415's public key that is associated with the private key used by NRF 415 for signing the Access Token Request (in block 1125 of FIG. 11A below) or for signing the Access Token itself (in block 1330 of FIG. 13A below).

FIGS. 11A-11C illustrate a first exemplary process for issuing an Access Token, and for authorizing a subscription for a consumer NF 100 to a resource provided by a producer NF 105 based on the issued Access Token. The exemplary process of FIGS. 11A-11C may be implemented by NRF 415 in conjunction with a requesting NF and a producer NF 105. The exemplary process of FIGS. 11A-11C may be executed when NRF 415 receives an access token request, associated with a subscription request for a resource of a producer NF 105, from a requesting entity, either on behalf of the requesting entity itself (e.g., a consumer NF 100) or on behalf of another consumer NF 100.

The exemplary process includes NRF 415 receiving an Access Token Request, associated with subscribing a consumer NF 100 to a a resource provided by a producer NF 105 (block 1100). The Access Token Request, among other data, may include a subscriber notification URI associated with the subscribing consumer NF 100. The Access Token Request may originate from the subscribing consumer NF 100 itself, or may originate from a requester (e.g., NF 120 of FIG. 1B) that may request the Access Token from the NRF 415 on behalf of the subscribing consumer NF 100. The requester may be another NF 120 acting legitimately on behalf of the subscribing consumer NF 100, or may be a mis-configured NF 120 acting mistakenly on behalf of the consumer NF 100. Additionally, the requester may be an attacker 200 impersonating a consumer NF 100 without the consumer NF 100's knowledge.

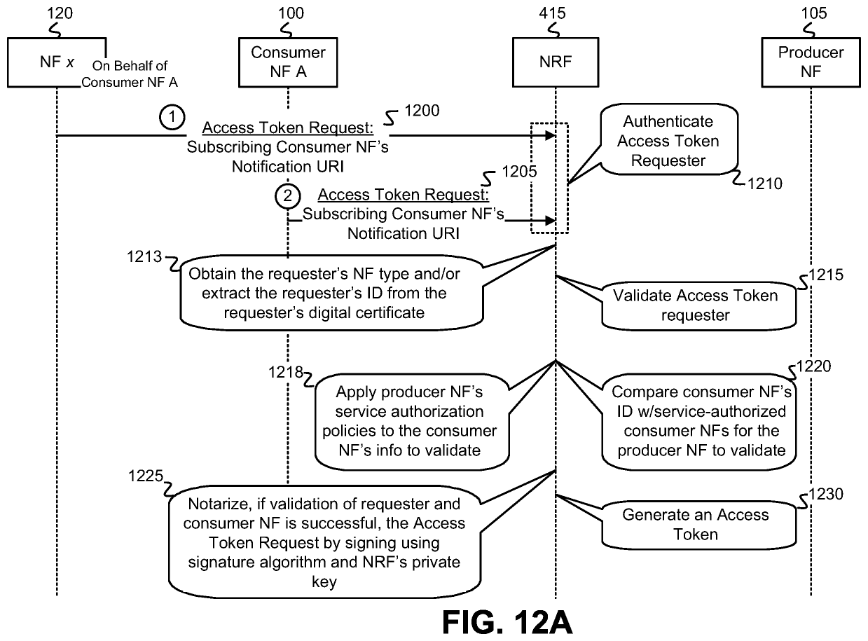

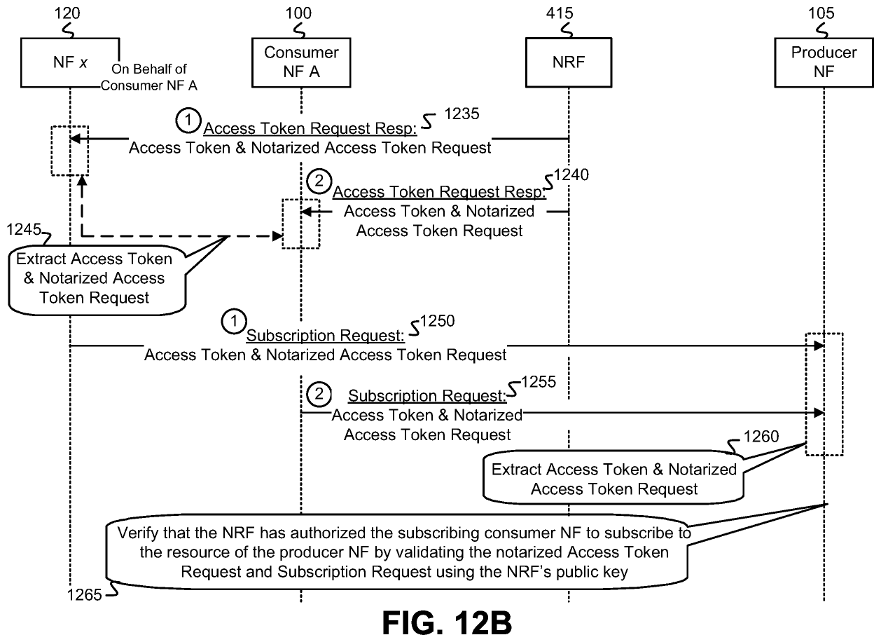

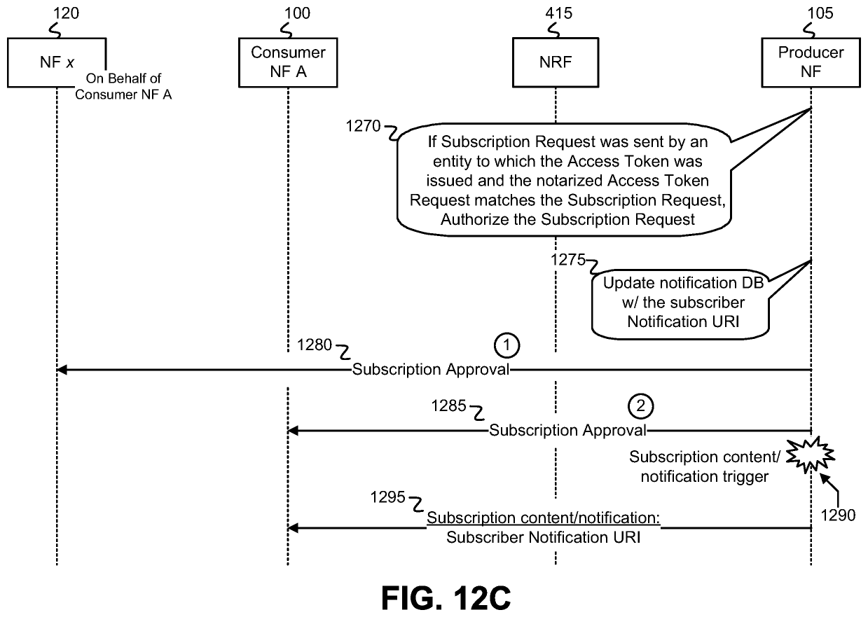

FIG. 12A depicts examples of two different circumstances of a NRF 415 receiving an Access Token Request. In a first circumstance (identified with a “1” within a circle), a NF 120, acting on behalf of a consumer NF A 100, sends an Access Token Request 1200 to the NRF 415 that includes, among other data, the notification URI associated with the consumer NF A 100. The NF 120 may act legitimately on behalf of the consumer NF A 100, or may be mis-configured and act mistakenly on behalf of the consumer NF A 100. Alternatively, the NF 120 may be an attacker that acts intentionally and maliciously, without the consumer NF A 100's knowledge, to request a subscription on behalf of the consumer NF A 100 to possibly cause, for example, a DoS attack at consumer NF A 100. In a second circumstance (identified with a “2” within a circle), the consumer NF A 100 itself sends an Access Token Request 1205 to the NRF 415 that includes, among other data, the notification URI associated with the consumer NF A 100.

NRF 415 determines if the Access Token requester can be authenticated (block 1105). NRF 415 may authenticate the Access Token requester by using, for example, existing certificate-based authentication techniques. In one embodiment, NRF 415 may obtain a digital certificate for the Access Token requester as part of a secure connection establishment process with the Access Token requester via a mutual Transport Layer Security (TLS) handshake process. The digital certificate may include, among other information, an ID associated with the Access Token requester. FIG. 12A shows NRF 415 authenticating 1210 the Access Token Requester.

If the Access Token requester could not be authenticated (NO—block 1105), then NRF 415 rejects the access token request (block 1110). If the Access Token requester was successfully authenticated (YES—block 1105), the NRF 415 obtains the requester's NF type and/or extracts the requester's identity from the requester's digital certificate (block 1115), and validates the Access Token requester and the subscribing consumer NF (block 1120). Validation of the Access Token requester may include comparing the requester's NF type with a list of approved types of NFs. Validation of the Access Token requester may additionally, or alternatively, include comparing the requester's ID (e.g., FQDN, UUID) with a list of approved requester IDs (e.g., FQDNs, UUIDs). Validation of the consumer NF 100 may, in one implementation, include applying the producer NF 105's service authorization policies (obtained in block 930 of the process of FIG. 9) to the consumer NF 100's information to determine whether the consumer NF 100's information satisfies the service authorization policies. In another implementation, validation of the consumer NF 100 may include comparing the consumer NF 100's ID with service-authorized consumer NFs for the producer NF 105 (obtained in block 925 of the process of FIG. 9) to determine whether the consumer NF 100's ID is among the service-authorized consumer NFs. In a further implementation, validation of the Access Token request may include both applying the producer NF 105's service authorization policies and comparing the consumer NF 100's ID with the service-authorized consumer NFs for the producer NF 105.

FIG. 12A depicts NRF 415 obtaining 1213 the NF x 120's NF type and/or extracting the NF x 120's identity from the requester's digital certificate, and validating 1215 the NF x 120 (as the Access Token Requester). FIG. 12A further shows NRF 415 applying 1218 the producer NF 105's service authorization policies to the consumer NF 100's information to determine whether to validate the consumer NF 100, and/or comparing 1220 the consumer NF 100's ID with service-authorized consumer NFs for the producer NF 105 to determine whether to validate the consumer NF 100.

NRF 415 notarizes, based on successful validation of the requester and the consumer NF 100, the Access Token Request, that includes the subscriber notification URI of the consumer NF 100 being subscribed to the producer NF 105's resource, by signing it using a signature algorithm and the NRF 415's private key (block 1125). To notarize the Access Token Request, the NRF 415 may apply a digital signature algorithm to the content of the Access Token Request, using the NRF 415's private key of a public/private key pair, resulting in the generation of a notarized Access Token Request. The signature algorithm may include any type of digital signature generating algorithm that may be implemented at both NRF 415 and at the producer NFs 105. The signature algorithm may include, for example, one of the HS256, ES256, DSA, ECDSA, EdDSA, RSA, ElGamal, or Schnorr digital signature algorithms. Other types of signature algorithms may, however, be used. The NRF 415's public key, of the private/public key pair, may have already been distributed to the producer NF 105 in block 940 of the process of FIG. 9. FIG. 12A shows NRF 415 notarizing 1225, if validation of the requester and the consumer NF is successful, the Access Token Request by signing it using the digital signature algorithm and the NRF's private key.

NRF 415 generates an Access Token based on the Access Token Request (block 1130), and inserts the Access Token and the notarized Access Token Request into an Access Token Request Response and sends the Response to the requester (block 1135)(FIG. 11B). NRF 415 generates Access Token 600 of FIG. 6, but possibly omitting optional Token fields 650 of payload 610 that include the type of service 665, the Resource ID 670, and the notification URI 675. The signature algorithm field 620 of the generated token 600 identifies the signature algorithm NRF 415 will use to generate the NRF signature. The key ID field 625 identifies the public key associated with the private key that NRF 415 will use to generate the NRF signature. NRF UUID field 635 includes the UUID of the NRF 415. NF consumer UUID field includes the UUID of the subscribing consumer NF 100. NF producer UUID 645 includes the UUID of the producer NF 105 to which a subscription of a resource is being requested. Token expiration field 655 identifies when the generated Access Token 600 is to expire. NRF signature field 660 stores the NRF signature that is generated by NRF 415 by applying the digital signature algorithm identified in field 620, using a private key that is the counterpart to the public key identified in key ID field 625, to header 605 and payload 610 of Access Token 600.

NRF 415 may maintain a log that stores the ID (e.g., network address) of the requester (e.g., NF 120) to which the Access Token and the notarized Access Token Request is sent, the Access Token, and the notarized Access Token Request. Subsequently, as described with respect to block 1160 below, NRF 415 may use the log to determine whether a Subscription Request includes an Access Token that was issued by the NRF 415 to the requester that sent the Subscription Request.

FIG. 12A shows NRF 415 generating 1230 an Access Token and FIG. 12B further shows NRF 415 sending an Access Token Request Response to either NF x 120 or consumer NF A 100. In a first circumstance (identified with a “1” within a circle), in which NF x 120, acting on behalf of consumer NF A 100, sent the Access Token Request to the NRF 415, NRF 415 returns an Access Token Request Response 1235 to NF x 120 that includes the issued Access Token (generated in block 1130 of FIG. 11A) and the notarized Access Token Request (from block 1125 of FIG. 11A). In a second circumstance (identified with a “2” within a circle), in which consumer NF A 100 itself sent the Access Token Request to the NRF 415, NRF 415 returns an Access Token Request Response 1240 to consumer NF A 100 that includes the issued Access Token (generated in block 1130 of FIG. 11A) and the notarized Access Token Request (from block 1125 of FIG. 11A).

The requester receives the Access Token Request Response and extracts the Access Token and the notarized Access Token Request (block 1140), and subsequently sends a Subscription Request to the producer NF 105 that includes the Access Token and the notarized Access Token Request (block 1145). The requester (e.g., consumer NF 100 or NF 120) may store the Access Token and the notarized Access Token Request in association with an ID of the producer NF 105 and an ID of the resource offered by the producer NF 105 to which the consumer NF 100 is to be subscribed. The requester may subsequently retrieve the Access Token and the notarized Access Token Request from memory, insert them into a Subscription Request along with the subscriber notification URI of the consumer NF 100 for whom a subscription is being requested, and send the Subscription Request to the producer NF 105 which provides the resource being subscribed to.

FIG. 12B depicts NF x 120 or consumer NF A 100 extracting 1245 the Access Token and the notarized Access Token Request from Access Token Request Responses 1235 or 1240. FIG. 12B further shows, in the first circumstance (identified with a “1” within a circle) in which NF x 120 sent the Access Token Request to the NRF 415 on behalf of consumer NF A 100, NF x 120 sends a Subscription Request 1250 to the producer NF 105 that includes the Access Token and notarized Access Token Request extracted from the Access Token Request Response 1235. FIG. 12B additionally shows, in the second circumstance (identified with a “2” within a circle), in which consumer NF A 100 itself sent the Access Token Request to the NRF 415, consumer NF A 100 sends a Subscription Request 1255 to the producer NF 105 that includes the Access Token and notarized Access Token Request extracted from the Access Token Request Response 1240.

The producer NF 105 receives the Subscription Request and extracts the Access Token and the notarized Access Token Request from the Subscription Request (block 1150), and verifies that the NRF 415 has authorized the consumer NF 100 to subscribe to a resource of the producer NF by validating the signature on the notarized Access Token Request using the NRF 415's public key (block 1155). By validating the signature on the notarized Access Token Request, the producer NF 105 is able to verify, with a high degree of assurance, that the requester has been authorized to access the resource. Alternatively, or additionally, validating the Subscription Request may involve producer NF 105 determining if the Subscription Request was sent by the entity to which the Access Token was issued. In this alternative, which may be performed as an alternative to, or in addition to, the Access Token Request signature validation described above, NRF 415 may maintain a log that stores the ID (e.g., network address) of the requester (consumer NF 120) to which the Access Token and the notarized Access Token Request was sent, the Access Token, and the notarized Access Token Request. The producer NF 105 may request the requester ID of the Access Token from NRF 415, and producer NF 105 may determine if the requester ID received from the NRF 415 matches the ID of the requester that sent the Subscription Request in block 1160.

Validating the notarized Access Token Request may involve producer NF 105 verifying the integrity and authenticity of the notarized Access Token Request, using the NRF 415's public key (e.g., previously distributed to the producer NF 105), to verify the digital signature associated with the Access Token Request received by the NRF 415 in block 1100. Validating the notarized Access Token Request may involve producer NF 105 decrypting the original content of the Access Token Request, and the producer NF 105 then comparing the decrypted original content of the Access Token Request recovered from the notarized Access Token Request with the content of the Subscription Request. One or more items of data within the content of the decrypted notarized Access Token Request may be compared with one or more items of data within the content of the Subscription Request to determine whether the data matches. For example, the producer NF 105 may compare the subscriber notification URI extracted from the Subscription Request with the subscriber notification URI contained in the decrypted content of the Access Token Request recovered from the notarized Access Token Request. Producer NF 105 verifies that the comparison indicates that the Subscription Request's subscriber notification URI matches the notarized Access Token Request's subscriber notification URI.

FIG. 12B depicts producer NF 105 extracting 1260 the Access Token and the notarized Access Token Request from the Subscription Requests 1250 or 1255. FIG. 12B further shows the producer NF 105 verifying 1265 that the NRF 415 has authorized the subscribing consumer NF A 100 to subscribe to the resource of the producer NF 105 by validating the notarized Access Token Request and the Subscription Request 1250 or 1255 using the NRF 415's public key.

If the producer NF 105 determines that the Subscription Request was not sent by the entity to which the Access Token was issued (NO—block 1160), or determines that the notarized Access Token Request content does not match content of the Subscription Request (NO—block 1170), then the producer NF 105 rejects the subscription request (block 1165). If the producer NF 105 determines that the Subscription Request was sent by the entity to which the Access Token was issued (YES—block 1160), and that certain content of the notarized Access Token Request matches certain content of the Subscription Request (YES—block 1170), then the producer NF 105 authorizes the subscription request, updates its notification database with the subscriber notification URI associated with the consumer NF 100, and returns a subscription approval to the Requester (block 1175). As shown in FIG. 12C, if the Subscription Request 1250 or 1255 was sent by an entity to which the Access Token was issued and the notarized Access Token Request matches the Subscription Request, then producer NF 105 authorizes 1270 the Subscription Request 1250 or 1255, updates 1275 the producer NF 105's notification DB with the subscriber notification URI associated with the consumer NF 100, and sends a Subscription Approval message 1280 to NF x 120 (in circumstance “1” in which the Subscription Request originates with NF x 120) or a Subscription Approval message 1285 to consumer NF A 100 (in circumstance “2” in which the Subscription Request originates with consumer NF 100 itself).

The producer NF 105 subsequently determines if a subscription content and/or notification trigger for the consumer NF 100's subscribed resource occurs (block 1180). The subscription content and/or notification trigger may include various different types of triggering events that cause producer NF 105 to send content, and/or a notification, for the subscribed resource to the consumer NF 100 at the subscriber notification URI. For example, an AMF 450 may be subscribed to policy updates from a PCF 460 in mobile network 305. Upon the production of a newest policy update for a session (i.e., a notification trigger), the PCF 460 sends the new policy updates to the subscribed AMF 450.

If the subscription content and/or notification trigger occurs (YES—block 1180), then the producer NF 105 sends subscription content and/or a notification associated with the subscribed resource to the subscriber notification URI (block 1185). FIG. 12C depicts an example of a subscription content/notification triggering event 1290 occurring for a resource to which consumer NF A 100 is subscribed, and the producer NF 105, in response to the triggering event 1290, sending a message 1295 that includes content and/or a notification associated with the subscription to the consumer NF A 100 at the subscriber notification URI.

FIGS. 13A-13D illustrate a second exemplary process for issuing an Access Token, and for authorizing a subscription for a consumer NF 100 to a resource provided by a producer NF 105 based on the issued Access Token. The exemplary process of FIGS. 13A-13D may not involve the Access Token Request notarization used in the authorization and validation process of FIGS. 11A-11C, but may add new payload fields to the issued Access Token that are integrity protected and optionally encrypted as part of NRF 415's digital signature generation process and subsequently used as part of the authorization and validation process.

The exemplary process of FIGS. 13A-13D may be implemented by NRF 415 in conjunction with a requesting NF and a producer NF 105. The exemplary process of FIGS. 13A-13D may be executed when NRF 415 receives an access token request, associated with a subscription request for a resource of a producer NF 105, from a requesting entity, either on behalf of the requesting entity itself (e.g., a consumer NF 100) or on behalf of another consumer NF 100.

The exemplary process includes NRF 415 receiving an Access Token Request, associated with subscribing a consumer NF 100 to a resource provided by a producer NF 105 (block 1300). The Access Token Request, among other data, may include a subscriber notification URI associated with the subscribing consumer NF 100. The Access Token Request may originate from the subscribing consumer NF 100 itself, or may originate from a requester (e.g., NF 120 of FIG. 1B) that may request the Access Token from the NRF 415 on behalf of the subscribing consumer NF 100. The requester may be another NF 120 acting legitimately on behalf of the subscribing consumer NF 100, or may be a mis-configured NF 120 acting mistakenly on behalf of the consumer NF 100. Additionally, the requester may be an attacker 200 impersonating the consumer NF 100 without the consumer NF 100's knowledge to possibly cause, for example, a DoS attack at the consumer NF 100.

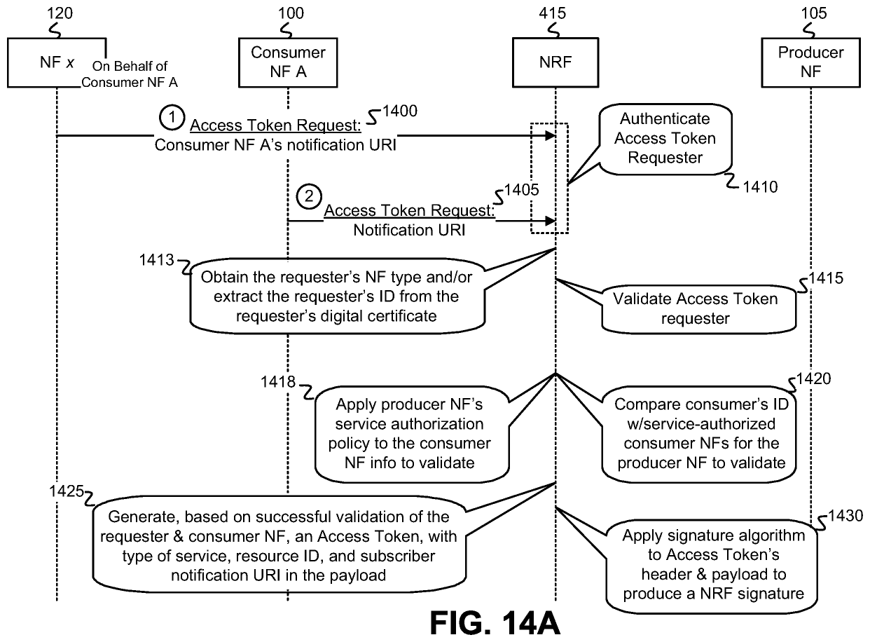

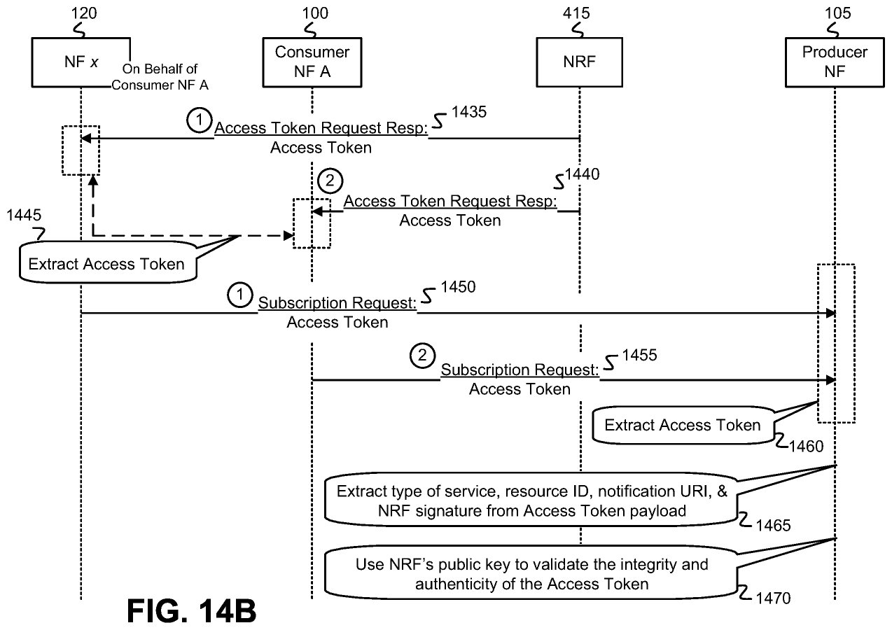

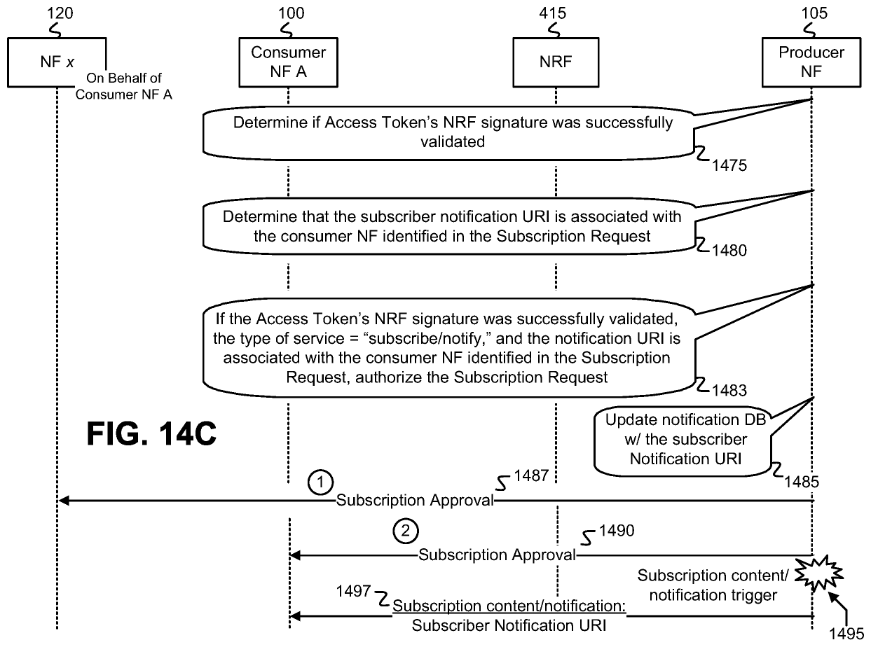

FIG. 14A depicts examples of two different circumstances of a NRF 415 receiving an Access Token Request. In a first circumstance (identified with a “1” within a circle), a NF 120, acting on behalf of a consumer NF A 100, sends an Access Token Request 1400 to the NRF 415 that includes, among other data, the notification URI associated with the consumer NF A 100. In a second circumstance (identified with a “2” within a circle), the consumer NF A 100 itself sends an Access Token Request 1405 to the NRF 415 that includes, among other data, the notification URI associated with the consumer NF A 100.

NRF 415 determines if the Access Token requester can be authenticated (block 1305). NRF 415 may authenticate the Access Token requester by using, for example, existing certificate-based authentication techniques. In one embodiment, NRF 415 may obtain a digital certificate (e.g., X.509v3 certificate) for the Access Token requester as part of a mutual TLS handshake process. The digital certificate may include, among other information, an ID associated with the Access Token requester (e.g., a FQDN associated with the Access Token requester). FIG. 14A shows NRF 415 authenticating 1410 the Access Token requester.

If the Access Token requester could not be authenticated (NO—block 1305), then NRF 415 rejects the access token request (block 1310). If the requester was successfully authenticated (YES—block 1305), the NRF 415 obtains the requester's NF type and/or extracts the requester's identity from the requester's digital certificate (block 1315), and validates the Access Token requester and the subscribing consumer NF (block 1320). Validation of the Access Token requester may include NRF 415 comparing the requester's NF type with a list of approved types of NFs (e.g., AMFs, SMFs, PCFs, etc.). Validation of the Access Token requester may additionally, or alternatively, include NRF 415 comparing the requester's ID with a list of approved requester IDs. The validation process may be part of a broader authorization process. Validation of the consumer NF 100 may, in one implementation, include applying the producer NF 105's service authorization policies (obtained in block 930 of the process of FIG. 9) to the consumer NF 100's information to determine whether the consumer NF 100's information satisfies the service authorization policies. In another implementation, validation of the consumer NF 100 may include comparing the consumer NF 100's ID with service-authorized consumer NFs for the producer NF 105 (obtained in block 925 of the process of FIG. 9) to determine whether the consumer NF 100's ID is among the service-authorized consumer NFs. In a further implementation, validation of the Access Token request may include both applying the producer NF 105's service authorization policies and comparing the consumer NF 100's ID with the service-authorized consumer NFs for the producer NF 105.

FIG. 14A depicts NRF 415 obtaining 1413 the NF x 120's or the consumer NF A 100's NF type and/or extracting the NF x 120's or the consumer NF A 100's identity from the requester's digital certificate, and validating 1415 the NF x 120 or the consumer NF A 100 (as the Access Token Requester). FIG. 14A further shows NRF 415 applying 1418 the producer NF 105's service authorization policies to the consumer NF 100's information to determine whether to validate the consumer NF 100, and/or comparing 1420 the consumer NF 100's ID with service-authorized consumer NFs for the producer NF 105 to determine whether to validate the consumer NF 100.

NRF 415 generates, based on successful validation of the requester and the consumer NF 100, an Access Token, with a type of service (e.g., a subscribe/notify service), a resource ID, and a subscriber notification URI in the payload (block 1325). NRF 415 generates Access Token 600 of FIG. 6, including the optional Token fields 650 of payload 610 that include the type of service 665, the Resource ID 670, and the notification URI 675. In the generated Access Token 600, the signature algorithm field 620 identifies the signature algorithm that NRF 415 will use to generate the NRF signature. The key ID field 625 identifies the public key associated with the private key that NRF 415 will use to generate the NRF signature. NRF UUID field 635 includes the UUID of the NRF 415. NF consumer UUID field includes the UUID of the subscribing consumer NF 100. NF producer UUID 645 includes the UUID of the producer NF 105 to which a subscription of a resource is being requested. Type of service field 665 identifies the type of service (e.g., subscribe/notify) being subscribed to by the consumer NF 100. Resource ID field 670 identifies the ID of the resource to which the consumer NF 100 is being subscribed. Notification URI field 675 includes the URI to which content and/or notifications associated with the subscribed resource is to be delivered to the consumer NF 100. Token expiration field 655 identifies when the Access Token 600 is to expire.

NRF 415 copies the header and payload data from the generated Access Token, encodes the header and payload data, and applies a signature algorithm, using the NRF 415's private key, to produce a NRF signature (block 1330), and inserts the NRF signature into the generated Access Token (block 1335 (FIG. 13B). In one implementation in which the Access Token is a JSON Web Token, NRF 415 copies the header 605 and the payload 610 from the Access Token 600 generated in block 1325, encodes the header 605 and payload 610 (e.g., using Base64url encoding), concatenates the encoded header 605 and payload 610 together, and applies the digital signature algorithm identified in field 620, using a private key that is the counterpart to the public key identified in key ID field 625, to the encoded and concatenated header 605 and payload 610 (where payload 610 includes the optional fields 650) to generate the NRF signature. NRF 415 inserts the generated NRF signature into NRF signature field 660 of the Access Token 600.

The digital signature algorithm identified in field 620 may include any type of digital signature generating algorithm that may be implemented at both NRF 415 and at the producer NFs 105. The signature algorithm may include, for example, one of the HS256, ES256, DSA, ECDSA, EdDSA, RSA, ElGamal, or Schnorr digital signature algorithms. Other types of signature algorithms may, however, be used. The NRF 415's public key, of the private/public key pair, may have already been distributed or pre-provisioned to the producer NF 105 in block 940 of the process of FIG. 9. FIG. 14A shows NRF 415 generating 1425, if validation of the requester and the consumer NF is successful, an Access Token, with a Type of Service, a resource ID, and a subscriber notification URI in the payload. FIG. 14A further shows NRF 415 applying 1430 a signature algorithm to the Access Token's encoded header and payload data to produce a NRF signature.

NRF 415 inserts the Access Token into an Access Token Request Response and sends the Response to the Access Token requester (block 1340). FIG. 14A shows NRF 415 sending an Access Token Request Response to either NF x 120 or consumer NF A 100. In a first circumstance (identified with a “1” within a circle), in which NF x 120, acting on behalf of consumer NF A 100, sent the Access Token Request to the NRF 415, NRF 415 returns an Access Token Request Response 1435 to NF x 120 that includes the issued Access Token (generated in blocks 1325-1335 of FIGS. 13A and 13B). In a second circumstance (identified with a “2” within a circle), in which consumer NF A 100 itself sent the Access Token Request to the NRF 415, NRF 415 returns an Access Token Request Response 1440 to consumer NF A 100 that includes the issued Access Token.

The requester receives the Access Token Request Response and extracts the Access Token (block 1345), and subsequently sends a Subscription Request to the producer NF 105 that includes the Access Token, the subscribing consumer NF 100's information, and the notification URI associated with the subscribing consumer NF 100 (block 1350). The requester (e.g., consumer NF 100 or NF x 120) may store the received Access Token in association with an ID of the producer NF 105 and an ID of the resource offered by the producer NF 105 to which the consumer NF 100 is to be subscribed. The requester may subsequently retrieve the Access Token from memory, insert it into a Subscription Request along with the subscriber notification URI of the consumer NF 100 for whom a subscription is being requested, and send the Subscription Request to the producer NF 105 which provides the resource being subscribed to.

FIG. 14B depicts NF x 120 or consumer NF A 100 extracting 1445 the Access Token from Access Token Request Responses 1435 or 1440. FIG. 14B further shows, in the first circumstance (identified with a “1” within a circle) in which NF x 120 sent the Access Token Request to the NRF 415 on behalf of consumer NF A 100, NF x 120 sends a Subscription Request 1450 to the producer NF 105 that includes the Access Token extracted from the Access Token Request Response 1435. FIG. 14B additionally shows, in the second circumstance (identified with a “2” within a circle), in which consumer NF A 100 itself sent the Access Token Request to the NRF 415, consumer NF A 100 sends a Subscription Request 1455 to the producer NF 105 that includes the Access Token extracted from the Access Token Request Response 1440.

The producer NF 105 receives the Subscription Request and extracts the content, including the Access Token, and the consumer NF 100's information (block 1355). The producer NF 105 further extracts the type of service, the resource ID, the notification URI, and the NRF signature from the Access Token (block 1360). The producer NF 105 extracts the type of service from field 665, the resource ID from field 670, and the notification URI from field 675. The producer NF 105 further extracts the NRF signature from field 660.

The producer NF 105 uses the NRF 415's public key (previously distributed to the producer NF 105) to validate the Access Token's NRF signature (block 1365). The producer NF 105 may optionally decrypt and recover the Access Token's payload if the Access Token was encrypted by NRF 415 (e.g., using a secret key that was shared and/or generated by the producer NF 105). In an implementation in which the Access Token 600 extracted from the Subscription Request is a JSON Web Token, producer NF 105 applies the digital signature algorithm identified in field 620 of the Token 600, using a public key identified in key ID field 625, to validate the NRF signature. Producer NF 105 separates the concatenated and encoded header 605 and payload 610 from the recovered header/payload data and decodes (e.g., using Base64url decoding) the encoded header 605 and payload 610 to produce the original content (to which the digital signature algorithm was applied in block 1330 of FIG. 13A) of the header 605 and payload 610 of the Access Token 600. FIG. 14B shows the producer NF 105 extracting 1460 the Access Token from the Subscription Request 1450 or Subscription Request 1455, and extracting 1465 the type of service, resource ID, notification URI, and NRF signature from the Access Token payload. FIG. 14B further shows the producer NF 105 using 1470 the NRF's public key to validate the integrity and authenticity of the Access Token.

Producer NF 105 determines if the Access Token's NRF signature was successfully validated (block 1370). As described above, the producer NF 105 uses the digital signature algorithm identified in field 620 of the Access Token 600, the public key identified in key ID field 625, and existing signature validation techniques to validate the NRF signature. FIG. 14C depicts the producer NF 105 determining 1475 if the Access Token's NRF signature was successfully validated in block 1365. If the Access Token's NRF signature was not successfully validated (NO—block 1370) or the decrypted Access Token payload's type of service does not equal “subscribe/notify” (NO—block 1380), then the producer NF 105 rejects the subscription request (block 1375).

In an implementation in which the Access Token payload is encrypted, the producer NF 105 may also compare the decrypted Access Token payload's subscriber notification URI (obtained in block 1365) with the original Access Token Request's subscriber notification URI to determine if they match. In this implementation, the producer NF 105 may compare the notification URI extracted from field 675 of the Access Token 600 with the notification URI obtained from the original Access Token request.

If the Access Token's NRF signature was successfully validated (YES—block 1370) and the decrypted Access Token payload's type of service equals “subscribe/notify” (YES—block 1380), then the producer NF 105 determines that the subscriber notification URI is associated with the consumer NF identified in the Subscription Request (block 1385), and authorizes the subscription request, updates its notification database with the subscriber notification URI associated with the consumer NF 100, and returns a subscription approval to the Requester (block 1388). Since the producer NF 105 has validated the NRF signature associated with the Access Token that also contained the subscriber notification URI, the producer NF 105 is able to determine that the URI is either associated with consumer NF 100 identified in the Subscription Request or that the consumer NF 100 has the authority to subscribe on behalf of another consumer. The producer NF 105, thus, may rely on the NRF 415 previously applying authorization rules to eliminate requests from improper consumer NFs 100 when the NRF 415 creates the Access Token and digitally signs the Access Token (in block 1335). FIG. 14C shows the producer NF 105 determining 1480 that the subscriber notification URI is associated with the consumer NF identified in the Subscription Request. As further shown in FIG. 14C, if the Access Token's NRF signature was successfully validated, the type of service in the Access Token is “subscribe/notify,” and the notification URI is associated with the consumer NF identified in the Subscription Request, then producer NF 105 authorizes 1483 the Subscription Request 1450 or 1455, updates 1485 the producer NF 105's notification DB with the subscriber notification URI associated with the consumer NF 100, and sends a Subscription Approval message 1487 to NF x 120 (in circumstance “1” in which the Subscription Request originates with NF x 120) or a Subscription Approval message 1490 to consumer NF A 100 (in circumstance “2” in which the Subscription Request originates with consumer NF 100 itself).

The producer NF 105 subsequently determines if a subscription content and/or notification trigger for the consumer NF 100's subscribed resource occurs (block 1390). As previously described, the subscription content and/or notification trigger may include various different types of triggering events that cause producer NF 105 to send content, and/or a notification, for the subscribed resource to the consumer NF 100 at the subscriber notification URI. If the subscription content and/or notification trigger occurs (YES—block 1390), then the producer NF 105 sends subscription content and/or a notification associated with the subscribed resource to the subscriber notification URI (block 1395). FIG. 14C depicts an example of a subscription content/notification triggering event 1495 occurring for a resource to which consumer NF A 100 is subscribed, and the producer NF 105, in response to the triggering event 1495, sending a message 1497 that includes content and/or a notification associated with the subscription to the consumer NF A 100 at the subscriber notification URI.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 7, 9, 11A-11C, and 13A-13D, and sequences of operations, messages, and/or data flows with respect to FIGS. 8, 10, 12A-12C, and 14A-14C, the order of the blocks and/or the operations, messages, and/or data flows may be varied in other implementations. Moreover, non-dependent blocks may be performed in parallel. Embodiments have been described herein as being implemented within networks employing OAuth, which is an open standard for access delegation that provides mechanisms for a secure delegated access to NF resources on behalf of the producer NFs that provide such resources. The techniques described herein may modify the OAuth standard, or may modify other access delegation authorization schemes not described herein.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 320) of a device. A non-transitory storage medium includes one or more of the storage mediums described in relation to memory 330. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device from a requester, an access token request associated with subscribing a consumer network function (NF) to a resource provided by a producer NF, wherein the access token request includes a notification identifier identifying where the consumer NF is to receive content and/or notifications that are associated with the resource, from the producer NF;
validating, by the network device, the requester;
generating an access token and an access token response based on successfully validating the requester;
signing the notification identifier as a component of the access token response; and
sending, by the network device, the access token response, with the signed notification identifier, to the requester for use in requesting a subscription to the resource for the consumer NF from the producer NF.

2. The method of claim 1, wherein signing the identifier as a component of the access token response comprises:
signing the access token request, that includes the notification identifier, using a signature generating technique and a private encryption key, to generate a notarized access token request; and
inserting the notarized access token request into the Access Token Response.

3. The method of claim 1, wherein generating the access token comprises:
inserting the notification identifier into a payload of the Access Token, and
wherein signing the notification identifier as a component of the access token response comprises:
signing a portion of the access token, that includes the payload, using a signature generating technique and a private encryption key, to generate an access token signature;
inserting the access token signature into the access token; and
inserting the access token into the access token response.

4. The method of claim 3, wherein generating the access token further comprises:
inserting, in addition to the notification identifier, a type of service identifier (ID) and a resource (ID) associated with the resource provided by the producer NF into the payload of the access token.

5. The method of claim 1, wherein the network device implements a Network Repository Function (NRF) of a network.

6. The method of claim 1, wherein the requester comprises one of the consumer NF or another NF that acts on behalf of the consumer NF.

7 The method of claim 1, wherein validating the requester comprises:
obtaining the requester's NF type and/or the requester's identifier (ID); and
validating the requester based on the requester's NF type or the requester's ID.

8. The method of claim 1, further comprising:
validating the consumer NF,
wherein generating the access token and the access token response is further based on successfully validating the consumer NF.

9. The method of claim 8, wherein validating the consumer NF comprises at least one of:
applying service authorization policies of the producer NF to information related to the consumer NF; or
comparing an ID of the consumer NF with service-authorized NFs of the producer NF.

10. A network device, comprising:
a communication interface coupled to a network and configured to:
receive, from a requester, an access token request associated with subscribing a consumer network function (NF) to a resource provided by a producer NF, wherein the access token request includes a notification identifier identifying where the consumer NF is to receive content and/or notifications that are associated with the service or resource, from the producer NF; and
a processor or logic configured to:
validate the requester,
generate an access token and an access token response based on successfully validating the requester,
sign the notification identifier as a component of the access token response, and
send, via the communication interface, the access token response, with the signed notification identifier, to the requester for use in requesting a subscription to the resource for the consumer NF from the producer NF.

11. The network device of claim 10, wherein, when signing the notification identifier as a component of the access token response, the processor or logic is further configured to:
sign the access token request, that includes the notification identifier, using a signature generating technique and a private encryption key, to generate a notarized access token request; and
insert the notarized access token request into the Access Token Response.

12. The network device of claim 10, wherein, when generating the access token, the processor or logic is further configured to insert the notification identifier into a payload of the Access Token, and
wherein, when signing the notification identifier as a component of the access token response, the processor or logic is further configured to:
sign a portion of the access token, that includes the payload, using a signature generating technique and a private encryption key, to generate an access token signature;
insert the access token signature into the access token; and
insert the access token into the access token response.

13. The network device of claim 10, wherein, when validating the requester, the processor or logic is configured to:
obtain the requester's NF type and/or the requester's identifier (ID); and
validate the requester based on the requester's NF type or the requester's ID.

14. The network device of claim 10, wherein the processor or logic is further configured to:
validate the consumer NF,
wherein generating the access token and the access token response is further based on successfully validating the consumer NF.

15. The network device of claim 14, wherein, when validating the consumer NF, the processor or logic is further configured to perform at least one of:
apply service authorization policies of the producer NF to information related to the consumer NF; or
compare an ID of the consumer NF with service-authorized NFs of the producer NF.

16. A non-transitory storage medium storing instructions executable by a network device, wherein the instructions comprise instructions to cause the network device to:
receive, from a requester, an access token request associated with subscribing a consumer network function (NF) to a resource provided by a producer NF, wherein the access token request includes a notification identifier identifying where the consumer NF is to receive content and/or notifications that are associated with the resource, from the producer NF;
validate the requester;
generate an access token and an access token response based on successfully validating the requester;
sign the notification identifier as a component of the access token response; and
send the access token response, with the signed notification identifier, to the requester for use in requesting a subscription to the resource for the consumer NF from the producer NF.

17. The non-transitory storage medium of claim 16, wherein the instructions to cause the network device to sign the notification identifier as a component of the access token response further comprise instructions to cause the network device to:
sign the access token request, that includes the notification identifier, using a signature generating technique and a private encryption key, to generate a notarized access token request; and
insert the notarized access token request into the Access Token Response.

18. The non-transitory storage medium of claim 16, wherein the instructions to cause the network device to generate the access token further comprise instructions to cause the network device to:
insert the notification identifier into a payload of the Access Token, and
wherein the instructions to cause the network device to sign the notification identifier as a component of the access token response further comprise instructions to cause the network device to:
sign a portion of the access token, that includes the payload, using a signature generating technique and a private encryption key, to generate an access token signature;
insert the access token signature into the access token; and
insert the access token into the access token response.

19. The non-transitory storage medium of claim 16, wherein the instructions further comprise instructions to cause the network device to:
validate the consumer NF,
wherein generating the access token and the access token response is further based on successfully validating the consumer NF.

20. The non-transitory storage medium of claim 19, wherein the instructions to cause the network device to validate the consumer NF further comprise instructions to cause the network device to perform at least one of:
apply service authorization policies of the producer NF to information related to the consumer NF; or
compare an ID of the consumer NF with service-authorized NFs of the producer NF.
